(19) United States
(12) Patent Application Publication
(10) Pub. No.: US 2025/0179320 A1
(43) Pub. Date: Jun. 5, 2025

(54) Ink Set And Recording Method

(71) Applicant: SEIKO EPSON CORPORATION, Tokyo (JP)

(72) Inventors: Shiho HAIZUKA, Shiojiri (JP); Ippei OKUDA, Shiojiri (JP)

(21) Appl. No.: 18/961,700

(22) Filed: Nov. 27, 2024

(30) Foreign Application Priority Data
Nov. 30, 2023 (JP) 2023-202797

(51) Int. Cl. C09D 11/54; B41M 7/00; C09D 11/322; C09D 11/38

(52) U.S. Cl. CPC C09D 11/54; B41M 7/009; C09D 11/322; C09D 11/38

(57) ABSTRACT

An ink set according to one embodiment of the present disclosure is an ink set including a color ink composition and a clear ink composition, and the ink set is used for a recording method in which the color ink composition and the clear ink composition are laminated and adhered to a recording medium by an ink jet method. The color ink composition is an aqueous composition containing a colorant, and the clear ink composition is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

The present application is based on, and claims priority from JP Application Serial Number 2023-202797, filed Nov. 30, 2023, the disclosure of which is hereby incorporated by reference herein in its entirety.

### BACKGROUND

### 1. Technical Field

The present disclosure relates to an ink set and a recording method.

### 2. Related Art

Since being able to record a highly fine image using a relatively simple apparatus, an ink jet recording method has been rapidly developed in various types of fields. Among the developments, in order to improve an abrasion resistance of a recorded matter, a study in which a clear ink containing a resin is used together with a color ink has been performed.

For example, JP-A-2019-147307 has disclosed an ink jet recording method for performing a main scanning having an area in which a recording region to which a color ink composition is ejected from an ink jet head by a main scanning and a recording region to which a clear ink composition containing a resin and a silicone-based surfactant is ejected from an ink jet head by the main scanning described above are laminated to each other.

In the case in which a clear ink is used, as the abrasion resistance, a dry abrasion resistance when a recorded matter is rubbed in a dry state and a wet abrasion resistance when a recorded matter is rubbed in a humid or a wetted environment may be mentioned, and depending on the conditions, the dry abrasion resistance may be inferior in some cases, or the wet abrasion resistance may be inferior in some cases. Hence, the dry abrasion resistance and the wet abrasion resistance both are required to be made excellent at the same time.

### SUMMARY

According to an aspect of the present disclosure, there is provided an ink set comprising a color ink composition and a clear ink composition, the ink set being used for a recording method in which the color ink composition and the clear ink composition are laminated and adhered to a recording medium by an ink jet method. In the ink set described above, the color ink composition is an aqueous composition containing a colorant, and the clear ink composition is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

According to another aspect of the present disclosure, there is provided a recording method using the ink set according to the aspect described above, the method comprising a step of adhering the color ink composition to a recording medium by an ink jet method, and a step of adhering the clear ink composition to the recording medium by an ink jet method. In the recording method described above, the color ink composition and the clear ink composition are laminated and adhered to the recording medium.

### BRIEF DESCRIPTION OF THE DRAWINGS

FIG. 1 is a schematic cross-sectional view showing an ink jet recording apparatus.

FIG. 2 is a perspective view showing one example of the structure in the vicinity of a carriage of the ink jet recording apparatus.

FIG. 3 is a schematic view showing one example of the arrangement of ink jet heads.

FIG. 4 is a schematic view showing one example of the arrangement of the ink jet heads.

FIG. 5 (TABLE 1) shows composition examples of clear ink compositions.

FIG. 6 (TABLE 2) shows composition examples of color ink compositions.

FIG. 7 (TABLE 3) shows evaluation results of Examples.

FIG. 8 (TABLE 4) shows evaluation results of Examples, Comparative Examples, and Reference Example.

### DESCRIPTION OF EMBODIMENTS

Hereinafter, embodiments of the present disclosure will be described. The following embodiments are to explain examples of the present disclosure. The present disclosure is not at all limited to the following embodiments and includes various types of modified and/or changed embodiments to be performed without departing from the scope of the present disclosure. In addition, all the constituents to be described below are not always required to be essential constituents of the present disclosure.

In this specification, the numerical range represented by using “˜” indicates a range in which the numerical values located at the left and the right sides of “˜” are a lower limit value and an upper limit value, respectively, of the range.

In this specification, “(meth)acryl” represents acryl or methacryl, and “(meth)acrylate” represents acrylate or methacrylate.

### 1. Ink Set

An ink set according to one embodiment of the present disclosure is an ink set including a color ink composition and a clear ink composition and is used for a recording method in which the color ink composition and the clear ink composition are laminated and adhered to a recording medium by an ink jet method. The color ink composition is an aqueous composition containing a colorant, and the clear ink composition is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

Heretofore, a study to improve the abrasion resistance of a recorded matter by using a clear ink containing a resin has been carried out. In addition, in an ink jet recording method, when a clear ink is also configured to be applied by an ink jet method, a necessary amount thereof can be applied to a necessary portion, and in addition, because of the non-contact application, a color image (image recorded using a color ink composition) is advantageously unlikely to be stained. Furthermore, since a color ink and a clear ink can be simultaneously or sequentially adhered, an advantage in terms of recording speed (productivity) can also be obtained.

However, even in the case of using a clear ink, the dry abrasion resistance may be inferior in some cases, or the wet abrasion resistance may be inferior in some cases. In addition to the case described above, it has also become to understand that because of the presence of a clear ink coating film, the dry abrasion resistance or the wet abrasion resistance may be degraded in some cases.

In consideration of the problems as described above, the research has been carried out, and as a result, it was found that when a silicone-based surfactant which has a dissolution amount of 1.0 to 3.0 parts by mass with respect to 100 parts by mass of a 1,2-hexanediol aqueous solution at a concentration of 3 percent by mass is used as a silicone-based surfactant to be contained in a clear ink, the dry abrasion resistance and the wet abrasion resistance both can be made excellent.

In addition, the “ink set” in the present disclosure indicates a set of inks including at least a color ink composition and a clear ink composition in combination. The ink set is a set of inks to be used for recording. The number of color ink compositions included in the ink set may be only one or may be at least two. The number of clear ink compositions included in the ink set is also similar to that described above.

### 1.1. Clear Ink Composition

The ink set according to this embodiment includes a clear ink composition, and the clear ink composition described above is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

The clear ink composition is neither a color ink composition nor an ink to be used for coloration, and although a colorant to be contained in the color ink composition described below may also be contained, a content of the colorant with respect to a total mass of the clear ink composition is preferably 0.5 percent by mass or less, more preferably 0.1 percent by mass or less, and further preferably 0.01 percent by mass or less. The contents described above include the case in which no colorant is contained (0 percent by mass).

Hereinafter, the components contained in the clear ink composition will be described.

### 1.1.1. Resin

The clear ink composition contains a resin. The resin has a function as a so-called fixing resin, for example, to improve the adhesion and the abrasion resistance of the ink component.

As the resin, for example, there may be mentioned an urethane-based resin, an acrylic-based resin (including a styrene-acrylic-based resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, or an ethylene-vinyl acetate-based resin. Among those resins mentioned above, an urethane-based resin, an acrylic-based resin, a polyolefin-based resin, or a polyester-based resin is preferable. Although those resins each may be a water-soluble resin and may also be in the form of resin particles, a resin in the form of particles is preferable. Although being frequently handled in the form of emulsion, the resin particles may also be handled in the form of powder. In addition, the resin may be used alone, or at least two types thereof may be used in combination.

The urethane-based resin is a generic name of a resin having an urethane bond. As the urethane-based resin, for example, there may be used a polyether type urethane resin having an ether bond in its main chain besides an urethane bond, a polyester type urethane resin having an ester bond in its main chain besides an urethane bond, or a polycarbonate type urethane resin having a carbonate bond in its main chain besides an urethane bond. In addition, as the urethane-based resin, a commercial product may also be used. For example, as the commercial product, there may be used Superflex 460, 460s, 840, or E-4000 (trade name, manufactured by DKS Co., Ltd.), Resamine D-1060, D-2020, D-4080, D-4200, D-6300, or D-6455 (trade name, Dainichiseika Color & Chemicals Mfg. Co., Ltd.), Takelac WS-6021 or W-512-A-6 (trade name, manufactured by Mitsui Chemicals Polyurethanes, Inc.), Suncure 2710 (trade name, manufactured by Lubrizol), or Permarine UA-150 (trade name, manufactured by Sanyo Chemical Industries, Ltd.).

The acrylic-based resin is a generic name of a polymer obtained by polymerization using at least an acrylic-based monomer, such as (meth)acrylic acid or a (meth)acrylate ester, as one component, and for example, a resin obtained from an acrylic-based monomer or a copolymer obtained from an acrylic-based monomer and another monomer may be mentioned. For example, an acryl-vinyl-based resin which is a copolymer obtained from an acrylic-based monomer and a vinyl-based monomer may be mentioned. In addition, as the vinyl-based monomer, for example, styrene may be mentioned.

As the acrylic-based monomer, for example, acrylamide or acrylonitrile may also be used. For a resin emulsion using an acrylic-based resin as a raw material, a commercial product may also be used, and for example, a commercial product selected from FK-854 (trade name, manufactured by Chuorika Kougyo Co., Ltd.), Movinyl 6969D, 6899D, 952B, and 718A (trade names, manufactured by The Nippon Synthetic Chemical Industry Co., Ltd.), and Nipol LX852 and LX874 (trade names, manufactured by Zeon Corporation) may be used.

In addition, in this specification, the acrylic-based resin may also include a styrene-acrylic-based resin which will be described below.

The styrene-acrylic-based resin is a copolymer obtained from a styrene monomer and a (meth)acrylic-based monomer, and for example, a styrene-acrylic acid copolymer, a styrene-methacrylic acid copolymer, a styrene-methacrylic acid-acrylate ester copolymer, a styrene-α-methylstyrene-acrylic acid copolymer, or a styrene-α-methylstyrene-acrylic acid-acrylate ester copolymer may be mentioned. As the styrene-acrylic-based resin, a commercial product may also be used, and for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF), Movinyl 966A or 975N (trade name, manufactured by The Nippon Synthetic Chemical Industry Co., Ltd.), or Vinyblan 2586 (trade name, manufactured by Nissin Chemical Industry Co., Ltd.) may be used.

The polyolefin-based resin is a resin having a structure skeleton of an olefin, such as ethylene, propylene, or butylene, and may be appropriately selected and used from known resins. As the olefin-based resin, a commercial product may also be used, and for example, Arrowbase CB-1200 or CD-1200 (trade name, manufactured by Unitika Ltd.) may be used.

In addition, the resin may be supplied in the form of emulsion, and as an example of a commercial product of the resin emulsion as described above, for example, there may be mentioned Microgel E-1002 or E-5002 (trade name, manufactured by Nippon Paint Co., Ltd., styrene-acrylic-based resin emulsion); Boncoat 4001 (trade name, manufactured by DIC Corporation, acrylic-based resin emulsion); Boncoat 5454 (trade name, manufactured by DIC Corporation, styrene-acrylic-based resin emulsion); Polysol AM-710, AM-920, AM-2300, AP-4735, AT-860, or PSASE-4210E (acrylic-based resin emulsion), Polysol AP-7020 (styrene-acrylic resin emulsion), Polysol SH-502 (vinyl acetate resin emulsion), Polysol AD-13, AD-2, AD-10, AD-96, AD-17, or AD-70 (ethylene vinyl acetate resin emulsion), or Polysol PSASE-6010 (ethylene-vinyl acetate resin emulsion) (trade name, manufactured by Showa Denko K.K.); Polysol SAE1014 (trade name, styrene-acrylic-based resin emulsion, manufactured by Zeon Corporation); Saivinol SK-200 (trade name, acrylic-based resin emulsion), manufactured by Saiden Chemical Industry Co., Ltd.); AE-120A (trade name, manufactured by JSR Corporation, acrylic resin emulsion); AE373D (trade name, manufactured by Emulsion Technology Co., Ltd., carboxy modified styrene-acrylic resin emulsion); Seikadyne 1900W (trade name, manufactured by Dainichiseika Color & Chemicals Mfg. Co., Ltd., ethylene-vinyl acetate resin emulsion); Vinyblan 2682 (acrylic resin emulsion), Vinyblan 2886 (vinyl acetate-acrylic resin emulsion), Vinyblan 5202 (acetic acid acrylic resin emulsion) (trade name, manufactured by Nissin Chemical Industry Co., Ltd.); Elitel KA-5071S, KT-8803, KT-9204, KT-8701, KT-8904, or KT-0507 (trade name, manufactured by Unitika Ltd., polyester resin emulsion); Hitech SN-2002 (trade name, manufactured by Toho Chemical Industry Co., Ltd., polyester resin emulsion); Takelac W-6020, W-635, W-6061, W-605, W-635, or W-6021 (trade name, manufactured by Mitsui Chemicals Polyurethanes, Inc., urethane-based resin emulsion); Superflex 870, 800, 150, 420, 460, 470, 610, or 700 (trade name, manufactured by DKS Co., Ltd., urethane-based resin emulsion); Permarin UA-150 (manufactured by Sanyo Chemical Industries, Ltd., urethane-based resin emulsion); Sancure 2710 (manufactured by Lubrizol Japan Ltd., urethane-based resin emulsion); NeoRez R-9660, R-9637, or R-940 (manufactured by Kusumoto Chemicals, Ltd., urethane-based resin emulsion); Adeka Bontighter HUX-380 or 290K (trade name, manufactured by ADEKA Corporation, urethane-based resin emulsion); Movinyl 966A or Movinyl 7320 (trade name, manufactured by The Nippon Synthetic Chemical Industry Co., Ltd.); Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF); NK Binder R-5HN (trade name, manufactured by Shin-Nakamura Chemical Co., Ltd.); or Hydran WLS-210 (trade name, non-crosslinkable polyurethane: manufactured by DIC Corporation).

A glass transition temperature Tg of the resin contained in the clear ink composition is preferably 0° C. or more, more preferably 30° C. or more, even more preferably 50° C. or more, further preferably 60° C. or more, and particularly preferably 70° C. or more. When the glass transition temperature Tg of the resin is particularly 60° C. or more, the dry abrasion resistance tends to be made more excellent. In addition, a clogging recovery property also tends to be made more excellent.

Although being not particularly limited, an upper limit of the glass transition temperature Tg of the resin is preferably 150° C. or less, more preferably 100° C. or less, and further preferably 80° C. or less.

The measurement of the glass transition temperature is performed, for example, in accordance with JIS K7121 (testing methods for transition temperatures of plastics) using a differential scanning calorimeter “DSC7000” manufactured by Hitachi High-Tech Science Corporation.

A content of the resin in the clear ink composition with respect to the total mass of the clear ink composition is as a solid content, 1 to 30 percent by mass, preferably 5 to 25 percent by mass, more preferably 10 to 20 percent by mass, and further preferably 11 to 15 percent by mass.

### 1.1.2. Specific Silicone-Based Surfactant

The clear ink composition contains a silicone-based surfactant (hereinafter, referred to as “specific silicone-based surfactant” in some cases) having a dissolution amount of 1.0 to 3.0 parts by mass with respect to 100 parts by mass of a 1,2-hexanediol aqueous solution at a concentration of 3 percent by mass.

It was found that when the dissolution amount of a silicone-based surfactant is high, the wet abrasion resistance is degraded. The reason for this is considered as described below. That is, when the dissolution amount described above is high, the surfactant has a high hydrophilicity and is liable to absorb a water component (moisture); hence, a clear ink coating film is swelled and dissolved, and the colorant in a color ink layer is re-dispersed.

On the other hand, it was also found that when the dissolution amount of a silicone-based surfactant is low, the dry abrasion resistance is degraded. The reason for this is considered as described below. That is, when the dissolution amount described above is low, the surfactant has a high hydrophobicity and is liable to have an affinity with an organic-based component, such as a resin, in a clear ink; hence, a drying property of an ink containing an organic-based component is degraded, and an ink coating film cannot be sufficiently dried. Since the silicone-based surfactant has a high boiling point and is not likely to be evaporated, an ink present together with an organic-based component tends to be degraded in terms of drying property.

In contrast, when the specific silicone-based surfactant is used, the balance between the hydrophilicity and the hydrophobicity is made excellent, and hence, the wet abrasion resistance and the dry abrasion resistance both can be made excellent.

In addition, it was also found that when the dissolution amount with respect to 100 parts by mass of a 1,2-hexanediol aqueous solution at a concentration of 3 percent by mass is confirmed, this dissolution amount can be used as the index of the balance between the hydrophilicity and the hydrophobicity, and hence, whether or not the silicone-based surfactant enables the wet abrasion resistance and the dry abrasion resistance to be excellent can be determined.

In addition, when a clear ink is applied by an ink jet method, in view of ink jet ejection stability, a silicone-based surfactant which is likely to decrease the surface tension of the ink is preferably contained. In particular, when the clear ink is applied to a low-absorbing or a non-absorbing recording medium, the silicone-based surfactant is preferable in terms of wet spreadability on a recording medium, and a necessary amount of the clear ink can be uniformly applied. On the other hand, since being difficult to decrease the surface tension described above, an acetylene glycol-based surfactant is inferior in terms of wet spreadability on a recording medium and ejection stability.

The dissolution amount of the surfactant with respect to 100 parts by mass of a 1,2-hexanediol aqueous solution at a concentration of 3 percent by mass was measured in a manner such that after 100 g of a 1,2-hexanediol aqueous solution at a concentration of 3 percent by mass is formed in a 100-mL beaker, and a predetermined amount of the surfactant is sequentially added thereto. After each addition is performed, the solution is lightly stirred by a stirrer and is then left to stand still for a certain period, and the degree of cloudiness of the solution is observed by visual inspection using black paper as a background. When the solution is not white-clouded, or when an undissolved remaining surfactant is not observed, it is judged that the surfactant is dissolved.

For example, when addition amounts of 0.1, 0.5, and 1 part by mass of the surfactant with respect to 100 parts by mass of the aqueous solution are investigated, after 0.1 g of the surfactant is added to 100 g of a 1,2-hexanediol aqueous solution at a concentration of 3 percent by mass, whether the surfactant is dissolved or not is judged, and subsequently, after 0.4 g of the surfactant is additionally added, whether the surfactant is dissolved or not is judged. Furthermore, after 0.5 g of the surfactant is additionally added, whether the surfactant is dissolved or not is judged. By the procedure as described above, the maximum mass of the surfactant which can be judged to be dissolved in the solution is confirmed.

As described above, the investigation described above is performed several times (such as three times or five times) for confirmation, and the average value of the mass of the surfactant thus confirmed is regarded as the dissolution amount. In addition, the measurement is performed in an environment at an ordinary temperature (25° C.).

The dissolution amount of the specific silicone-based surfactant with respect to 100 parts by mass of a 1,2-hexanediol aqueous solution at a concentration of 3 percent by mass is 1.0 to 3.0 percent by mass, preferably 1.5 to 2.8 percent by mass, more preferably 1.8 to 2.7 percent by mass, and further preferably 2.0 to 2.5 percent by mass.

The specific silicone-based surfactant is preferably a silicone-based surfactant represented by the following formula (1). When the silicone-based surfactant as described above is used, the dissolution amount thereof can be easily controlled in the range described above. In addition, since the silicone-based surfactant described above has the structure in which the two terminals are modified, when the length of a main skeleton having a siloxane bond other than that having a polyether modified group portion is adjusted, the molecular weight and the dissolution amount described above both can be easily controlled in respective preferable ranges. Accordingly, the balance between the hydrophilicity and the hydrophobicity can be made excellent, and the wet abrasion resistance and the dry abrasion resistance both tend to be made excellent.

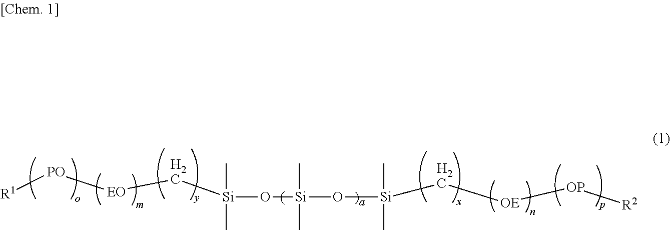

In the formula, a represents an integer of 1 to 30, x and y each independently represent an integer of 1 to 4, m and n each independently represent an integer of 1 to 20, o and p each independently represent an integer of 0 to 20, m+n represent 2 to 40, o+p represents 0 to 40, R¹ and R² are each independently selected from the group consisting of a hydrogen atom, a hydroxy group, an alkyl group having 1 to 6 carbon atoms, and a (meth)acryl group. E and P represent an ethylene group and a propylene group, respectively. The order between OE(EO) units and OP(PO) units is not particularly limited.

In the formula (1), although a represents an integer of 1 to 30, a is preferably 25 or less, more preferably 20 or less, even more preferably 2 to 17, further preferably 5 to 15, and particularly preferably 7 to 13.

Although x and y each independently represent an integer of 1 to 4, x and y are each preferably 1 to 3 and more preferably 2 to 3.

Although m and n each independently represent an integer of 1 to 20, m and n are each preferably 2 to 15, more preferably 4 to 10, and further preferably 5 to 8.

Although o and p each independently represent an integer of 0 to 20, 0 and p are each preferably 0 to 10, more preferably 0 to 5, even more preferably 0 to 3, further preferably 0 to 1, and particularly preferably 0.

Although m+n is 2 to 40, m+n is preferably 4 to 30, more preferably 8 to 20, and further preferably 10 to 15.

Although o+p is 0 to 40, o+p is preferably 0 to 20, more preferably 0 to 10, even more preferably 0 to 3, further preferably 0 to 1, and particularly preferably 0.

Although R¹ and R² are each independently selected from the group consisting of a hydrogen atom, a hydroxy group, an alkyl group having 1 to 6 carbon atoms, and a (meth)acryl group, R¹ and R² each independently preferably represent a hydroxy group. The order between OE(EO) units and OP(PO) units is not particularly limited, that is, when the number of OE(EO) units and the number of OP(PO) units are each one or more, the order of each OE(EO) unit and each OP(PO) unit is not particularly limited.

Although P represents a propylene group, 1,2-propylene group or 1,3-propylene group may be mentioned, and 1,2-propylene group is preferable.

The specific silicone-based surfactant is also preferably a silicone-based surfactant represented by the following formula (2).

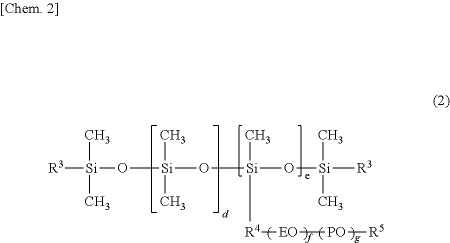

In the formula, R³s each independently represent an alkyl group having 1 to 6 carbon atoms, R⁴ represents an alkylene group having 1 to 4 carbon atoms, R⁵ represents a group selected from the group consisting of a hydrogen atom, a hydroxy group, an alkyl group having 1 to 6 carbon atoms, and a (meth)acryl group, EO represents an ethylene oxide group, PO represents a propylene oxide group, the order between EO units and PO units is not particularly limited, d and e each represent an integer of 1 or more, d+e represents an integer of 2 to 50, f represents an integer of 1 to 20, and g represents an integer of 0 to 20.

Although being an integer of 1 to 50 in the formula (2), d+e is preferably 1 to 25, more preferably 1 to 20, even more preferably 1 to 17, further preferably 1 to 15, even further preferably 1 to 13, and particularly preferably 1 to 7. d and e each preferably a half of d+e.

Although R⁴ represents an alkylene group having 1 to 4 carbon atoms, the number of carbon atoms thereof is preferably 1 to 3 and more preferably 2 to 3.

Although being an integer of 1 to 20, f is preferably 2 to 15, more preferably 4 to 10, and further preferably 5 to 8.

Although being an integer of 0 to 20, g is preferably 0 to 10, more preferably 0 to 5, even more preferably 0 to 3, further preferably 0 to 1, and particularly preferably 0.

Although being selected from the group consisting of a hydrogen atom, a hydroxy group, an alkyl group having 1 to 6 carbon atoms, and a (meth)acryl group, R⁵ preferably represents a hydroxy group.

The specific silicone-based surfactant may be obtained by synthesis. For example, by an addition reaction between a silicone oil having a Si—H structure and a polyether having a carbon-carbon double bond at its terminal, the specific silicone-based surfactant can be synthesized.

In the case of the silicone-based surfactant represented by the formula (1), in more particular, by an addition reaction between a silicone oil represented by the following formula (A) and a polyether represented by the following formula (B) using a Pt-based catalyst or the like, the silicone-based surfactant described above is preferably synthesized. Accordingly, the silicone-based surfactant represented by the above formula (1) can be preferably synthesized.

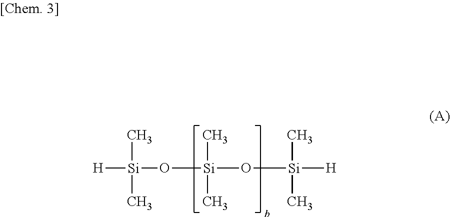

In the formula, b represents an integer of 1 to 30.

b is a numerical value corresponding to a of the formula (1) of the silicone-based surfactant to be obtained and may be in a preferable range of a of the formula (1).

In the formula (A), although being an integer of 1 to 30, b is preferably 25 or less, more preferably 20 or less, even more preferably 2 to 17, further preferably 5 to 15, and particularly preferably 7 to 13.

In the case of the silicone-based surfactant of the formula (2), in more particular, by an addition reaction between a silicon oil in which a polyether modified group including R⁴ of the formula (2) is replaced by a hydrogen atom and a polyether represented by the following formula (B) using a Pt-based catalyst or the like, the silicone-based surfactant described above is preferably Synthesized. In the case described above, the silicon oil also has a Si—H structure.

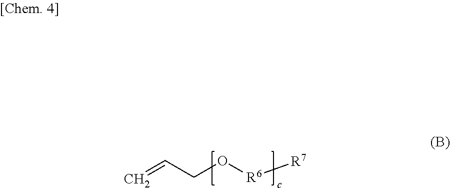

In the formula, c represents an integer of 1 to 40, R⁶ represents an ethylene group or a propylene group, R⁷ is selected from the group consisting of a hydrogen atom, a hydroxy group, an alkyl group having 1 to 6 carbon atoms, and a (meth)acryl group.

In the formula (B), the allyl group of the formula (B) reacts with —H of the Si—H of the silicone oil to form the polyether modified group of the formula (1) or (2).

When the silicone-based surfactant of the formula (1) is obtained, a polyether of the formula (B) which corresponds to the polyether modified group of the formula (1) may be used.

When the silicone-based surfactant of the formula (2) is obtained, a polyether of the formula (B) which corresponds to the polyether modified group of the formula (2) may be used.

In addition, c preferably represents an integer of 1 to 20. When R⁶ represents an ethylene group, c is preferably 2 to 15, more preferably 4 to 10, and further preferably 5 to 8.

Although c represents an integer of 1 to 20, when R⁶ represents a propylene group, c is preferably 1 to 10, more preferably 1 to 5, and further preferably 1 to 3.

Although R⁶ represents an ethylene group or a propylene group, an ethylene group is preferable.

Although being selected from the group consisting of a hydrogen atom, a hydroxy group, an alkyl group having 1 to 6 carbon atoms, and a (meth)acryl group, R⁷ preferably represents a hydroxy group.

In a molecular weight distribution by a gel permeation chromatography (GPC), the specific silicone-based surfactant is preferably a silicone-based surfactant in which the maximum peak in a molecular weight range of 300 or more is located in a molecular weight range of 1,000 to 3,000.

When the silicone-based surfactant is as described above, since the dissolution amount described above can be easily controlled in the range described above, the balance between the hydrophilicity and the hydrophobicity is made excellent, and the wet abrasion resistance and the dry abrasion resistance both tend to be made excellent.

In the molecular weight distribution by a gel permeation chromatography, although the maximum peak in a molecular weight range of 300 or more is preferably located in a molecular weight range of 1,000 to 3,000, the maximum peak described above is located in a range of more preferably 1,200 to 2,500, even more preferably 1,300 to 2,000, further preferably 1,400 to 1,800, and particularly preferably 1,500 to 1,700.

The maximum peak of the silicone-based surfactant in a molecular weight range of 300 or more can be identified by a molecular weight distribution chart of GPC in which the horizontal axis represents “logarithmic value of molecular weight M (Log M)” and the vertical axis represents “differential value of concentration fraction (dw/d(Log M))”. In addition, the “maximum peak” in this case indicates the maximum peak among peaks (mountains) located in a molecular weight range of 300 or more. In addition, the “maximum peak in a molecular weight range of 300 or more” indicates that peaks located at a molecular weight of less than 300 are ignored. That is, although a maximum peak located at a molecular weight of less than 300 may be present, the “maximum peak” described above is limited to the maximum peak located in a molecular weight range of 300 or more.

Although being not particularly limited, for example, the conditions of the GPC measurement of this embodiment may be set to the conditions described in Examples, and the molecular weight can be identified using standard polystyrenes.

A content of the specific silicone-based surfactant with respect to the total mass of the clear ink composition is preferably 1.5 percent by mass or less, more preferably 1.0 percent by mass or less, even more preferably 0.5 percent by mass or less, further preferably 0.4 percent by mass or less, and particularly preferably 0.3 percent by mass or less. In addition, a lower limit of the content of the specific silicone-based surfactant with respect to the total mass of the clear ink composition is preferably 0.01 percent by mass or more, more preferably 0.05 percent by mass or more, even more preferably 0.10 percent by mass or more, further preferably 0.15 percent by mass or more, even further preferably 0.2 percent by mass or more, and particularly preferably 0.25 percent by mass or more.

When the content described above is in particular, 0.3 percent by mass or less, the wet abrasion resistance tends to be made more preferable. In addition, a surfactant separation in the ink is not likely to occur.

The clear ink composition may also contain, besides the specific silicone-based surfactant described above, at least one of other surfactants. As the other surfactants, for example, a silicone-based surfactant other than the above specific silicone-based surfactant, an acetylene glycol-based surfactant, and/or a fluorine-based surfactant may be mentioned.

As the silicone-based surfactant other than the specific silicone-based surfactant described above, for example, there may be mentioned BYK-333 (trade name, manufactured by BYK Japan KK, the dissolution amount with respect to 100 parts by mass of a 1,2-hexanediol aqueous solution at a concentration of 3 percent by mass is 0.7 parts by mass, and in a molecular weight distribution by a GPC measurement, the maximum peak in a molecular weight range of 300 or more is located in a range of 4,000 to 7,000), BYK-348 (trade name, manufactured by BYK Japan KK, the dissolution amount is 5 parts by mass, and the maximum peak is located at 1,540), BYK-3480 (trade name, manufactured by BYK Japan KK, the dissolution amount is 0.1 parts by mass, and the maximum peak is located in a range of 4,000 to 4,500), BYK-349 (trade name, manufactured by BYK Japan KK, the dissolution amount is 0.1 parts by mass, and the maximum peak is located in a range of 1,400 to 1,500), Silface SAG503A (trade name, manufactured by Nissin Chemical Industry Co., Ltd., the maximum peak is located in a range of 1,500 to 1,900), or PD508 (trade name, manufactured by Nissin Chemical Industry Co., Ltd., the maximum peak is located at 6,230).

The acetylene glycol-based surfactant is not particularly limited, and for example, there may be mentioned 2,4,7,9-tetramethyl-5-decyne-4,7-diol, an alkylene oxide adduct thereof, 2,4-dimethyl-5-decyne-4-ol, or an alkylene oxide adduct thereof.

As a commercial product of the acetylene glycol-based surfactant, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (trade name, manufactured by Air Products & Chemicals, Inc.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (trade name, manufactured by Nissin Chemical Industry Co., Ltd.); or Acetylenol E00, E00P, E40, or E100 (trade name, manufactured by Kawaken Fine Chemicals Co., Ltd.).

The fluorine-based surfactant is not particularly limited, and for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl betaine, or a perfluoroalkylamine oxide compound.

As a commercial product of the fluorine-based surfactant, for example, there may be mentioned BYK-3440 (trade name, manufactured by BYK Japan KK), Surflon S-241, S-242, or S-243 (trade name, manufactured by AGC Seimi Chemical Co., Ltd.), or Ftergent 215M (trade name, manufactured by Neos Co., Ltd.).

A content of the other surfactants with respect to the total mass of the clear ink composition is preferably 0.1 percent by mass or less, more preferably 0.05 percent by mass or less, and further preferably 0.01 percent by mass or less, and the other surfactants are particularly preferably not contained (0 percent by mass).

### 1.1.3. Water

The clear ink composition is an aqueous composition. The “aqueous” composition indicates a composition which contains at least water as a solvent component and may contain water as a primary solvent component.

As the water, for example, there may be mentioned pure water, such as ion exchange water, ultrafiltration water, reverse osmosis water, or distilled water; or ultrapure water in which ionic impurities are removed as much as possible. In addition, by the use of water sterilized by UV radiation, addition of hydrogen peroxide, or the like, when the clear ink composition is stored for a long time, generation of bacteria and fungi can be suppressed.

A content of the water in a liquid medium component is preferably 50 percent by mass or more, more preferably 50 to 100 percent by mass, even more preferably 70 to 100 percent by mass, further preferably 90 to 100 percent by mass, and particularly preferably 95 to 99 percent by mass. The liquid medium indicates a solvent component, such as water or an organic solvent.

In addition, a content of the water with respect to the total mass of the clear ink composition is preferably 40 percent by mass or more, more preferably 50 percent by mass or more, even more preferably 60 percent by mass or more, further preferably 70 percent by mass or more, and particularly preferably 80 percent by mass or more. Although being not particularly limited, an upper limit of the content of the water with respect to the total mass of the clear ink composition is preferably, for example, 99 percent by mass or less and more preferably 90 percent by mass or less.

### 1.1.4. Amine

The clear ink composition preferably contains an amine having a standard boiling point of 250° C. or more. When an amine having a standard boiling point of 250° C. or more is contained, a moisture retaining property of the ink is not only made more excellent, but the clogging recovery property can also be made preferable; however, since the drying property of the ink is degraded, the wet abrasion resistance may be inferior in some cases. On the other hand, according to the ink set of this embodiment, even when an amine having a standard boiling point of 250° C. or more is contained, while the clogging recovery property is made preferable, the wet abrasion resistance also tends to be made preferable.

As the amine, for example, an aliphatic amine, an aromatic amine, or a heterocyclic amine may be mentioned. Among those mentioned above, an aliphatic amine is preferable, and in particular, an alkanolamine which is a compound having a hydroxy group and an amine group in its alkane skeleton is more preferable.

As the alkanolamine having a standard boiling point of 250° C. or more, for example, there may be mentioned diethanolamine (standard boiling point: 268° C., phase at 25° C.: solid [melting point: 28° C.]), N-ethyldiethanolamine (standard boiling point: 251° C., phase at 25° C.: liquid), N-butyldiethanolamine (standard boiling point: 275° C., phase at 25° C.: liquid), N-tert-butyldiethanolamine (alias: tBDEA, standard boiling point: 271° C., phase at 25° C.: solid [melting point]49° C.]), triethanolamine (alias: TEA, standard boiling point: 335° C., phase at 25° C.: liquid), triisopropanolamine (alias: TPA, standard boiling point: 305° C., phase at 25° C.: solid [melting point] 45° C.]), 2-amino-1,3-propanediol (standard boiling point: 274° C., phase at 25° C.: solid [melting point]52° C.]), 2-amino-2-hydroxymethyl-1,3-propanediol (standard boiling point: 288° C., phase at 25° C.: solid [melting point]170° C.]), 2-amino-2-methyl-1,3-propanediol (standard boiling point: 260° C., phase at 25° C.: solid [melting point]108° C.]), or 2-amino-2-ethyl-1,3-propanediol (standard boiling point: 259° C., phase at 25° C.: solid [melting point]34° C.]).

Among the alkanolamines having a standard boiling point of 250° C. or more, at least one selected from the group of triethanolamine and triisopropanolamine is preferable.

Although being preferably 250° C. or more, the standard boiling point of the amine is more preferably 270° C. or more, further preferably 290° C. or more, and particularly preferably 300° C. or more. When the standard boiling point described above is in the range as described above, the clogging recovery property tends to be made more excellent.

Although being not particularly limited, an upper limit range of the standard boiling point of the amine is preferably 350° C. or less and more preferably 340° C. or less.

A content of the amine having a standard boiling point of 250° C. or more with respect to the total mass of the clear ink composition is preferably 1 percent by mass or less, more preferably 0.5 percent by mass or less, even more preferably 0.4 percent by mass or less, further preferably 0.3 percent by mass or less, and particularly preferably 0.2 percent by mass or less. When the content described above is, in particular, 0.4 percent by mass or less, the balance between the moisture retaining property and the drying property is made excellent, the clogging recovery property tends to be made preferable, and in addition, the dry abrasion resistance and the wet abrasion resistance both also tend to be made preferable.

Although being not particularly limited, a lower limit range of the content of the amine having a standard boiling point of 250° C. or more is preferably 0.05 percent by mass or more, more preferably 0.1 percent by mass or more, and further preferably 0.15 percent by mass or more.

### 1.1.5. Organic Solvent

The clear ink composition may also contain an organic solvent. As the organic solvent, for example, an ester, an alkylene glycol ether, a cyclic ester, an amide, an alcohol, or a polyvalent alcohol may be mentioned. A water-soluble organic solvent is preferable.

As the ester, for example, there may be mentioned a glycol monoacetate, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxybutyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, or dipropylene glycol acetate propionate.

As the alkylene glycol ether, for example, a monoether or a diether of an alkylene glycol may be used, and an alkyl ether is preferable. As a concrete example, for example, there may be mentioned an alkylene glycol monoalkyl ether, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, or tripropylene glycol monobutyl ether; or an alkylene glycol dialkyl ether, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methylethyl ether, diethylene glycol methylbutyl ether, triethylene glycol dimethyl ether, triethylene glycol diethyl ether, triethylene glycol dibutyl ether, triethylene glycol methylbutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether.

As the cyclic ester, for example, there may be mentioned a cyclic ester (lactone), such as β-propiolactone, γ-butyrolactone, δ-valerolactone, ϵ-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ϵ-heptanolactone, γ-octanolactone, δ-octanolactone, ϵ-octanolactone, δ-nonalactone, ϵ-nonalactone, or ϵ-decanolactone; or a compound in which a hydrogen atom of a methylene group adjacent to the carbonyl group thereof is replaced by an alkyl group having 1 to 4 carbon atoms.

As the amide, for example, a cyclic amide or an acyclic amide may be mentioned. As the acyclic amide, for example, an alkoxyalkylamide may be mentioned.

As the cyclic amide, for example, a lactam may be mentioned. As the lactam, for example, a pyrrolidone, such as 2-pyrrolidone, 1-methyl-2-pyrrolidone, 1-ethyl-2-pyrrolidone, 1-propyl-2-pyrrolidone, or 1-butyl-2-pyrrolidone, may be mentioned.

As the alkoxyalkylamide, for example, there may be mentioned 3-methoxy-N,N-dimethylpropionamide, 3-methoxy-N,N-diethylpropionamide, 3-methoxy-N,N-methyethyllpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, or N,N-dimethylisobutyramide.

As the alcohol, for example, a compound in which one hydrogen atom of an alkane is replaced by a hydroxy group may be mentioned. As the alkane, an alkane having 10 carbon atoms or less is preferable, an alkane having 6 carbon atoms or less is more preferable, and an alkane having 3 carbon atoms or less is further preferable. The number of carbon atoms of the alkane is one or more and is preferably 2 or more. The alkane may have either a linear structure or a branched structure. As the alcohol, for example, there may be mentioned methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxyethanol, benzyl alcohol, or phenoxypropanol.

The polyvalent alcohol is a compound having at least two hydroxy groups in its molecule. As the polyvalent alcohol, for example, an alkanediol or a polyol may be mentioned.

As the alkanediol, for example, a compound in which hydrogen atoms of an alkane are replaced by two hydroxy groups may be mentioned. As the alkanediol, for example, a 1,2-alkanediol which is a generic name of a compound in which hydrogen atoms of an alkane located at the positions 1 and 2 are replaced by hydroxy groups or an alkanediol other than the 1,2-alkanediol may be mentioned.

As the 1,2-alkanediol, for example, there may be mentioned ethylene glycol, 1,2-propanediol (propylene glycol), 1,2-butanediol (1,2BD), 1,2-penetanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, or 3-ethyl-4-methyl-1,2-hexanediol.

As the other alkanediols, for example, there may be mentioned 1,3-propanediol, 1,3-butylene glycol (alias: 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 2-methylpentane-2,4-diol, 1,6-hexanediol, 2-ethyl-2-methyl-1,3-propanediol, and 2-methyl-2-propyl-1,3-propanediol. Among the alkanediols, an alkanediol having 5 carbon atoms or more is preferable, and an alkanediol having 5 to 10 carbon atoms is more preferable.

As the polyol, for example, an intermolecular condensate in which at least two alkanediol molecules are condensed between hydroxy groups or a compound having at least three hydroxy groups may be mentioned.

As the intermolecular condensate in which at least two alkanediol molecules are condensed between hydroxy groups, for example, a dialkylene glycol, such as diethylene glycol or dipropylene glycol, or a trialkylene glycol, such as triethylene glycol or tripropylene glycol, may be mentioned.

The compound having at least three hydroxy groups is a compound having an alkane or a polyether structure as its skeleton and at least three hydroxy groups. As the compound having at least three hydroxy groups, for example, there may be mentioned glycerin, trimethylolethane, trimethylolpropane, 1,2,5-hexanetriol, 1,2,6-hexanetriol, pentaerythritol, or a poly(oxypropylene)triol.

The organic solvent may be used alone, or at least two types thereof may be used in combination.

A content of the organic solvent with respect to the total mass of the clear ink composition is preferably 5 percent by mass or less, more preferably 3 percent by mass or less, and further preferably 1 percent by mass or less, and the organic solvent is particularly preferably not contained (0 percent by mass).

On the other hand, the organic solvent may be contained in some cases, and the content thereof with respect to the total mass of the clear ink composition is preferably 1 percent by mass or more, more preferably 1 to 40 percent by mass, even more preferably 3 to 30 percent by mass, further preferably 5 to 25 percent by mass, and particularly preferably 7 to 20 percent by mass.

In addition, a content of the polyvalent alcohol may be set in the range described above. In addition, a content of the alkanediol may also be preferably set in the range described above.

Furthermore, a content of the alkanediol having 5 carbon atoms or more with respect to the total mass of the clear ink composition is preferably 0.5 percent by mass or more, more preferably 1 to 20 percent by mass, even more preferably 2 to 15 percent by mass, and further preferably 3 to 10 percent by mass.

With respect to the total mass of the clear ink composition, an organic solvent which belongs to a polyvalent alcohol having a standard boiling point of more than 280° C. is preferably not contained at a content of more than 1 percent by mass, more preferably not contained at a content of more than 0.5 percent by mass, and further preferably not contained at a content of more than 0.1 percent by mass. In addition, with respect to the total mass of the clear ink composition, all organic solvents not limited to the polyvalent alcohol having a standard boiling point of more than 280° C. are each preferably not contained at a content of more than 1 percent by mass, more preferably not contained at a content of more than 0.5 percent by mass, and further preferably not contained at a content of more than 0.1 percent by mass. In the case described above, for example, the abrasion resistance of the recorded matter can be preferably made more excellent.

### 1.1.6. Other Components

As long as maintaining the functions, the clear ink composition may also contain, besides the components described above, components, such as an additive, a resin dispersant, an antiseptic/fungicide agent, antirust agent, a chelating agent, a viscosity adjuster, and/or an antioxidant.

As the additive, for example, an urea, a betaine, or a saccharide may be mentioned.

As the urea, for example, there may be mentioned urea, ethyleneurea, tetramethylurea, thiourea, or 1,3-dimethyl-2-imidazolidinone, and in addition, a betaine, such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, or acetylcarnitine, may also be mentioned.

As the saccharide, for example, there may be mentioned glucose, mannose, fructose, ribose, xylose, arabinose, galactose, aldonic acid, glucitol (sorbit), maltose, cellobiose, lactose, sucrose, trehalose, or maltotriose.

### 1.2. Color Ink Composition

The ink set according to this embodiment includes a color ink composition, and this color ink composition is an aqueous composition containing a colorant.

Hereinafter, the components contained in the color ink composition will be described.

### 1.2.1. Colorant

The color ink composition contains a colorant. As the colorant, for example, a pigment and a dye may be mentioned.

### Pigment

As the pigment, for example, inorganic pigments, such as carbon black and titanium white, and organic pigments may be used.

As the inorganic pigment, a carbon black (C.I. Pigment Black 7), such as a furnace black, a lamp black, an acetylene black, or a channel black, iron oxide, titanium oxide, zinc oxide, or silica may be used.

As the carbon black, for example, there may be mentioned No. 2300, 900, MCF88, No. 20B, No. 33, No. 40, No. 45, No. 52, MA7, MA8, MA100, or No2200B (manufactured by Mitsubishi Chemical Co., Ltd.). Carbon Black FW1, FW2, FW2V, FW18, FW200, S150, S160, S170, Pretex 35, U, V, 140U, Special Black 6, 5, 4A, 4, or 250 (manufactured by Degussa) may be mentioned by way of example. Conductex SC, Raven 1255, 5750, 5250, 5000, 3500, 1255, or 700 (manufactured by Columbia Carbon Inc.) may be mentioned by way of example. In addition, Regal 400R, 330R, 660R, Mogul L, Monarch 700, 800, 880, 900, 1000, 1100, 1300, 1400, or Elftex 12 may be mentioned by way of example.

As the organic pigment, for example, there may be mentioned by way of example, a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment.

The colorant of the color ink composition is preferably a quinacridone-based pigment. While being excellent in color development property and weather resistance, the quinacridone-based pigment is liable to be re-dispersed by a water component. Hence, when a color ink composition containing a quinacridone-based pigment is used, the wet abrasion resistance thereof may be inferior in some cases. On the other hand, according to the ink set of this embodiment, even when a color ink composition containing a quinacridone-based pigment is used, a preferable wet abrasion resistance tends to be obtained.

As the quinacridone-based pigment, for example, there may be mentioned C.I. Pigment Red 122, 209, or 202, C.I. Pigment Violet 19, or C.I. Pigment Orange 48 or 49.

As a concrete example of the organic pigment used for the color ink composition, the following may be mentioned.

As a cyan pigment, for example, C.I. Pigment Blue 1, 2, 3, 15:3, 15:4, 15:34, 16, 22, or 60: or C.I. Vat Blue 4 or 60 may be mentioned, and preferably, for example, one selected from the group consisting of C.I. Pigment Blue 15:3, 15:4, and 60 may be used alone, or at least two types thereof may be used in combination as a mixture.

As a magenta pigment, for example, C.I. Pigment Red 5, 7, 12, 48(Ca), 48(Mn), 57(Ca), 57:1, 112, 122, 123, 168, 184, 202, or 209; or C.I. Pigment violet 19 may be mentioned, and preferably, for example, one selected from the group consisting of C.I. Pigment Red 122, 202, and 209; and C.I. Pigment Violet 19 may be used alone, or at least two types thereof may be used in combination as a mixture. The pigments mentioned above each may also be in the form of solid solution.

As a yellow pigment, for example, C.I. Pigment Yellow 1, 2, 3, 12, 13, 14C, 16, 17, 73, 74, 75, 83, 93, 95, 97, 98, 109, 110, 114, 128, 129, 138, 150, 151, 154, 155, 180, or 185 may be mentioned, and preferably, for example, one selected from the group consisting of C.I. Pigment Yellow 74, 109, 110, 128, 138, 155, and 180 may be used alone, or at least two types thereof may be used in combination as a mixture.

As an orange pigment, C.I. Pigment Orange 36, 43, or a mixture thereof may be mentioned by way of example. As a green pigment, C.I. Pigment Green 7, 36, or a mixture thereof may be mentioned by way of example.

In addition, a photoluminescent pigment may also be used, and although any substance may be used as long as having photoluminescence when adhered to a medium, for example, there may be mentioned metal particles (also called a metal pigment) of a metal selected from the group consisting of aluminum, silver, gold, platinum, nickel, chromium, tin, zinc, indium, titanium, and copper or an alloy containing at least two metals thereof or a pearl pigment having pearl gloss. As a typical example of the pearl pigment, for example, a pigment having pearl gloss or interferential gloss, such as titanium dioxide coated mica, fish scale flakes, or bismuth acid chloride, may be mentioned. In addition, in order to suppress a reaction with water, the photoluminescent pigment may be processed by a surface treatment.

In addition, a white pigment may also be used, and for example, a metal compound, such as a metal oxide, barium sulfate, or calcium carbonate, may be mentioned. As the metal oxide, for example, titanium dioxide, zinc oxide, silica, alumina, or magnesium oxide may be mentioned. In addition, as the white pigment, particles having a hollow structure may also be used.

The pigments mentioned above may be used alone, or at least two types thereof may be used in combination. In view of storage stability, such as light resistance, weather resistance, and gas resistance, the pigment is preferably an organic pigment.

A volume average particle diameter (D50) of the pigment measured by a dynamic light scattering method is 20 to 300 nm, preferably 30 to 200 nm, and more preferably 40 to 100 nm.

The measurement of the volume average particle diameter may be performed using a particle size distribution measurement apparatus of the Nanotrac Series (manufactured by MicrotracBel Corp.). In addition, as a method to adjust the volume average particle diameter, for example, there may be mentioned a method to adjust the degree of pulverization of the pigment before it is dispersed, a method to adjust stirring conditions (such as a stirring speed and a stirring temperature) when the pigment is dispersed, or an adjusting method by filtration using a filter after the pigment is dispersed.

The pigment may be dispersed using a dispersant. In addition, the pigment may be dispersed as a self-dispersible pigment after pigment surfaces are oxidized or sulfonated using ozone, hypochlorous acid, fuming sulfuric acid, or the like.

The pigment dispersant has a function to disperse a pigment in a color ink composition. Although the pigment dispersant may be water soluble, a pigment dispersant not having a perfect water solubility is preferable, and the reason for this is believed such that since the dispersant is partially or totally adsorbed or bonded to the pigment so as to enhance a hydrophilic property of the surface of the pigment, the pigment can be dispersed. The pigment dispersant is preferably a high molecular weight compound and is more preferably a resin. In addition, a pigment dispersed by a pigment dispersant which is a resin is also called, in particular, a resin dispersion pigment.

As the resin of the pigment dispersant, for example, there may be mentioned an acrylic-based resin, such as a poly(meth)acrylic acid, a (meth)acrylic acid-acrylonitrile copolymer, a (meth)acrylic acid-(meth)acrylate ester copolymer, a vinyl acetate-(meth)acrylate ester copolymer, a vinyl acetate-(meth)acrylic acid copolymer, a vinylnaphthalene-(meth)acrylic acid copolymer, a styrene-(meth)acrylic acid copolymer, a styrene-(meth)acrylate ester copolymer, a styrene-(meth)acrylic acid-(meth)acrylate ester copolymer, a styrene-α-methylstyrene-(meth)acrylic acid copolymer, or a styrene-α-methylstyrene-(meth)acrylic acid-(meth)acrylate ester copolymer; or a salt thereof. In addition, in this specification, a polymer which has a skeleton derived from (meth)acrylic acid and which has not a skeleton derived from maleic acid or an analog thereof is called an acrylic-based resin.

In addition, as the resin of the pigment dispersant, for example, there may be mentioned a maleic acid-based resin, such as a styrene-maleic acid copolymer, a styrene-maleic anhydride copolymer, a vinylnaphthalene-maleic acid copolymer, or a vinyl acetate-maleate ester copolymer, or a salt thereof; an urethane-based resin regardless of whether or not having a cross-linking structure or its salt; a poly(vinyl alcohol); or a vinyl acetate-crotonic acid copolymer or its salt.

In addition, besides the polymers formed of an acrylic-based monomer as described above, the acrylic-based resin may be a copolymer obtained from an acrylic-based monomer and another monomer. For example, an acrylic vinyl resin which is a copolymer using a vinyl monomer as the another monomer is also called the acrylic-based resin. In addition, for example, among the styrene-based resins mentioned above, a copolymer obtained from a styrene-based monomer and an acrylic-based monomer is also included in the acrylic-based resin. Furthermore, the acrylic-based resin of this embodiment also includes a salt and an ester compound thereof.

As a commercial product of the pigment dispersant, for example, there may be mentioned X-200, X-1, X-205, X-220, or X-228 (manufactured by Seiko PMC Corporation); Nopcosparse (registered trademark) 6100 or 6110 (manufactured by San Nopco Co., Ltd.); Joncryl 67, 586, 611, 678, 680, 682, or 819 (manufactured by BASF); DISPER BYK-190 (manufactured by BYK Japan KK): or N-EA137, N-EA157, N-EA167, N-EA177, N-EA197D, N-EA207D, or E-EN10 (manufactured by DKS Co., Ltd.).

As a commercial product of the acrylic-based pigment dispersant, for example, there may be mentioned BYK-187, BYK-190, BYK-191, BYK-194N, or BYK-199 (manufactured by BYK Japan KK); or Aron A-210, A6114, AS-1100, AS-1800, A-30SL, A-7250, or CL-2 (manufactured by Toagosei Company, Limited).

As a commercial product of the urethane-based pigment dispersant, for example, there may be mentioned BYK-182, BYK-183, BYK-184, or BYK-185 (manufactured by BYK Japan KK); TEGO Disperse 710 (manufactured by Evonic Tego Chemi); or Borchi (registered trademark) Gen 1350 (manufactured by OMG Borschers).

The pigment dispersant may be used alone, or at least two types thereof may be used in combination. A total content of the pigment dispersant with respect to 100 percent by mass of the color ink composition is 0.1 to 30 percent by mass, preferably 5 to 25 percent by mass, and more preferably 10 to 20 percent by mass. Since the content of the pigment dispersant is 0.1 percent by mass or more, a dispersion stability of the pigment can be secured. In addition, when the content of the pigment dispersant is 30 percent by mass or less, the viscosity of the color ink composition can be suppressed to be low.

In addition, the pigment dispersant more preferably has a weight average molecular weight of 500 or more. Since the pigment dispersant as described above is used, the odor is reduced, and the dispersion stability of the pigment can be made more preferable.

When the pigment is dispersed using a pigment dispersant, a ratio of the pigment to the pigment dispersant is preferably 10:1 to 1:10 and more preferably 4:1 to 1:3.

The self-dispersible pigment is a pigment which is surface modified, for example, by directly or indirectly binding to the surface, at least one functional group selected from the group consisting of a carbonyl group, a carboxy group, an aldehyde group, a hydroxy group, a sulfone group, an ammonium group, and a salt thereof.

As the self-dispersible pigment, for example, there may be mentioned an organic pigment, such as an azo lake, an insoluble azo pigment, a condensed azo pigment, a chelate azo pigment, a phthalocyanine pigment, a perylene pigment, a perinone pigment, a quinacridone pigment, a thioindigo pigment, an isoindolinone pigment, a quinophthalone pigment, a dioxazine pigment, an anthraquinone pigment, a nitro pigment, a nitroso pigment, or an aniline black; or an inorganic pigment, such as titanium white, zinc oxide, lead white, carbon black, red iron oxide, vermilion, cadmium red, chrome yellow, ultramarine blue, cobalt blue, cobalt purple, or zinc chromate.

Among those self-dispersible pigments mentioned above, the carbon black is preferable since a black color can be printed at a high density, and an ejection reliability can be made more excellent.

As the self-dispersible pigment, a preparation or a commercial product prepared by a known method may be used. As the commercial product, for example, “Microjet CW1” or “Microjet CW2” manufactured by Orient Chemical Co., Ltd., or “CAB-O-JET 200” or “CAB-O-JET 300” manufactured by Cabot may be mentioned.

### Dye

The color ink composition may use a dye as the colorant. Although the dye is not particularly limited, for example, an acidic dye, a direct dye, a reactive dye, a basic dye, and a disperse dye may be usable.

A content of the dye with respect to the total mass of the color ink composition is not particularly limited, and the content described above is preferably 0.1 to 15 percent by mass, more preferably 0.5 to 10 percent by mass, even more preferably 1 to 8 percent by mass, further preferably 1.5 to 6 percent by mass, and particularly preferably 2 to 5 percent by mass.

### 1.2.2. Water

The color ink composition is an aqueous composition. The “aqueous” composition is similar to that described in the above clear ink composition and is to be explained using the “color ink composition” instead of using the “clear ink composition”.

A content of the water with respect to the total mass of the color ink composition may be set similar to that of the clear ink composition described above. Furthermore, the content described above is preferably 65 percent by mass or more, more preferably 80 percent by mass or more, even more preferably 90 percent by mass or more, and further preferably 95 percent by mass or more. Although being not particularly limited, for example, an upper limit of the content of the water with respect to the total mass of the color ink composition is preferably 99 percent by mass or less and more preferably 98 percent by mass or less.

### 1.2.3. Surfactant

The color ink composition may contain a surfactant. As the surfactant, for example, the above silicone-based surfactant (specific silicone-based surfactant) having a dissolution amount of 1.0 to 3.0 parts by mass with respect to 100 parts by mass of a 1,2-hexanediol aqueous solution at a concentration of 3 percent by mass and at least one of surfactants other than the specific silicone-based surfactant may be mentioned. Those surfactants are similar to those described in the above clear ink composition and are to be explained using the “color ink composition” instead of using the “clear ink composition”.

In this embodiment, the clear ink compositions is laminated and adhered to the region of a recording medium to which the color ink composition is adhered. Hence, the color ink composition layer is protected by the clear ink composition. Accordingly, even when the surfactant contained in the color ink composition is a surfactant other than the specific silicone-based surfactant described above, the abrasion resistance of the recorded matter is not likely to be degraded. On the other hand, since the clear ink composition to protect the color ink composition layer contains the specific silicone-based surfactant described above, the abrasion resistance of the recorded matter can be made excellent. In addition, the degree of freedom of designing the composition of the color ink composition is preferably increased.

A content of the surfactant with respect to the total mass of the color ink composition is preferably 1.0 percent by mass or less, more preferably 0.5 percent by mass or less, even more preferably 0.4 percent by mass or less, and further preferably 0.3 percent by mass or less. In addition, a lower limit of the content of the surfactant with respect to the total mass of the color ink composition is preferably 0.01 percent by mass or more, more preferably 0.05 percent by mass or more, further preferably 0.10 percent by mass or more, and particularly preferably 0.15 percent by mass or more.

### 1.2.4. Organic Solvent

The color ink composition may also contain an organic solvent. The organic solvent is similar to that described in the above clear ink composition and is to be explained using the “color ink composition” instead of using the “clear ink composition”.

### 1.2.5. Amine

The color ink composition may also contain an amine. The amine is similar to that described in the above clear ink composition and is to be explained using the “color ink composition” instead of using the “clear ink composition”.

### 1.2.6. Other Components

The color ink composition used for the recording method according to this embodiment may contain other components. The other components are similar to those described in the above clear ink composition and are to be explained using the “color ink composition” instead of using the “clear ink composition”.

### 1.3. Application

The ink set according to this embodiment is used for a recording method in which the color ink composition and the clear ink composition described above are laminated and adhered to a recording medium by an ink jet method. As the recording method as described above, the following recording method is preferable.

As a mode in which a color ink composition and a clear ink composition are laminated and adhered to a recording medium by an ink jet method, for example, a mode (first adhesion mode) in which a color ink composition and a clear ink composition are sequentially adhered to a recording medium and are laminated to each other and a mode (second adhesion mode) in which a color ink composition and a clear ink composition are simultaneously adhered to a recording medium may be mentioned. The details will be described later.

The recording medium is not particularly limited, and for example, an absorbing recording medium, a low-absorbing recording medium, or a non-absorbing recording medium may be mentioned. In order to more reliably obtain the effect of the present disclosure, the material of the recording medium is preferably a non-absorbing or a low-absorbing material and more preferably a non-absorbing material.

The low-absorbing or the non-absorbing recording medium indicates a recording medium which hardly absorbs a liquid or which absorbs no liquid at all, respectively. In a quantitative point of view, the non-absorbing or the low-absorbing recording medium indicates “a recording medium having a water absorption amount of 10 mL/m² or less from a contact start to 30 mseconds^{1/2} measured by Bristow method”. This Bristow method is the most popular measurement method of a liquid absorption amount in a short time and has also been employed by Japan Technical Association of the Pulp and Paper Industry (JAPAN TAPPI). The details of the test method have been disclosed in Standard No. 51 “Paper and Paperboard-Liquid Absorption Test Method-Bristow Method”, JAPAN TAPPI PAPER AND PULP TEST METHODS, 2000. On the other hand, the absorbing recording medium indicates a recording medium corresponding to neither the non-absorbing recording medium nor the low-absorbing recording medium.

As the low-absorbing recording medium, for example, a recording medium in which a low-absorbing coating layer is provided on a substrate surface may be mentioned, and the above recording medium is called coating paper. For example, as coating paper having a substrate made of paper, printing paper, such as art paper, coated paper, or mat paper, may be mentioned, and as coating paper having a substrate made of a plastic film, for example, there may be mentioned paper in which a plastic surface formed, for example, from a poly(vinyl chloride), a poly(ethylene terephthalate), a polycarbonate, a polystyrene, a polyurethane, a polyethylene, or a polypropylene is coated, for example, with a polymer or is coated with particles of silica, titanium, or the like together with a binder.

As the non-absorbing recording medium, for example, a medium in which a plastic is coated on a substrate formed of paper or the like, a medium in which a plastic film is adhered to a substrate formed of paper or the like, or a plastic film having no absorbing layer (receiving layer) may be mentioned. As the plastic in this case, for example, there may be mentioned a poly(vinyl chloride), a poly(ethylene terephthalate), a polycarbonate, a polystyrene, a polyurethane, a polyethylene, or a polypropylene.

As the recording medium, there may be preferably used a polyolefin-based film substrate having a surface with a surface roughness Sa of 0.3 μm or more to which the ink is adhered. The recording medium as described above is liable to generate a fine powder when the surface thereof is rubbed. Since the fine powder described above abrades an ink coating film of an image portion, the dry abrasion resistance is liable to be degraded. On the other hand, according to the ink set of this embodiment, even when the recording medium as described above is used, the dry abrasion resistance and the wet abrasion resistance tend to be made preferable.

A “polyolefin-based” resin is a generic name of a polymer formed using an alkene (olefin) as a monomer. For example, a polyethylene or a polypropylene may be mentioned.

The “surface roughness Sa” indicates the average of absolute values of differences (z(x,y)) in height at measurement points from an average surface in a reference area A and is represented by the following equation. The detail of the “surface roughness Sa” is defined in ISO 25178. The “surface roughness Sa” is also called the “arithmetic mean height Sa” in some cases.

$$Sa = ( 1 / A ) \int {\int }_{A} \vert z ( x , y ) \vert {d}_{x} {d}_{y}$$

The surface roughness Sa can be measured, for example, by a method in accordance with ISO 25178 using a laser microscope (VK-X1000/manufactured by Keyence Corporation).

The surface roughness Sa of the surface of the recording medium to which the ink is adhered is preferably 0.3 μm or more, more preferably 0.4 μm or more, further preferably 0.5 μm or more, and particularly preferably 0.6 μm or more. Although being not particularly limited, an upper limit of the surface roughness Sa is preferably 1.0 μm or less and more preferably 0.8 μm or less.

The recording medium may contain inorganic particles in a substrate surface. As the inorganic particles, for example, an inorganic oxide, such as silica including colloidal silica, titanium dioxide, aluminium oxide (alumina), zinc oxide, antimony oxide, magnesium oxide, or zirconium oxide; an inorganic carbonate salt, such as calcium carbonate, or an inorganic sulfate salt, such as calcium sulfate, may be preferably used, and a mixture thereof may also be used.

The shape of the inorganic particle is not particularly limited, and for example, a spherical shape, a bar shape, a prayer beads shape formed of beads connected to each other, or a needle shape may be used. Among those mentioned above, a spherical shape or a bar shape is preferable, and a spherical shape is particularly preferable.

In addition, the shape of the inorganic particle can be confirmed by observation using a scanning electron microscope. The “spherical shape” in the present disclosure approximately indicates, when observation is performed using a scanning electron microscope, the shape other than a prayer beads shape formed of primary particles connected to each other, a bar shape, a needle shape, and the like and is not limited to a true sphere and an oval sphere.

### 2. Recording Method

A recording method according to an embodiment of the present disclosure is a recording method for performing recording using the ink set described above and includes a step of adhering the color ink composition to a recording medium by an ink jet method and a step of adhering the clear ink composition to the recording medium by an ink jet method, and as a result, the color ink composition and the clear ink compositions are laminated and adhered to the recording medium.

Since the recording method according to this embodiment uses the ink set described above, the dry abrasion resistance and the wet abrasion resistance both can be made excellent.

In the recording method according to this embodiment, as the mode in which the color ink composition and the clear ink composition of the ink set described above are laminated and adhered to the recording medium, for example, the following two modes may be mentioned.

Incidentally, the terms used in the recording method according to this embodiment will be described. In addition, in this specification, when the color ink composition and the clear ink composition are not particularly discriminated from each other, those inks each may be simply called the “ink composition”.

An “ink jet method” is a method for ejecting liquid droplets of an ink or the like from nozzles of an ink jet head so as to be adhered to a recording medium.

A “main scanning” indicates an operation in which while a relative position of an ink jet head with respect to a recording medium is transferred, an ink jet composition is ejected from the ink jet head and is adhered to a recording medium. The ink jet head can be mounted, for example, in a carriage. The ink jet head may be configured to be transferred by the transfer of the carriage, and also in the case described above, that is, the ink jet head is transferred.

A “main scanning direction” is a transfer direction of the relative position of the ink jet head with respect to the recording medium and is a width direction of the recording medium. In addition, the “main scanning” is the transfer of the relative position of the ink jet head with respect to the recording medium, and the ink jet head may be transferred with respect to the recording medium, or the recording medium may be transferred with respect to the ink jet head. The direction of the transfer of the relative position as described above is the main scanning direction. The transfer of the relative position of the ink jet head with respect to the recording medium may also be regarded as the transfer of the relative position of the recording medium with respect to the ink jet head. That is, the “main scanning” described above indicates the transfer of the relative position between the ink jet head and the recording medium.

A “sub scanning” indicates an operation in which the relative position between the ink jet head and the recording medium is transferred in a sub scanning direction. The “sub scanning direction” is a direction intersecting the main scanning direction.

For example, when the ink composition is adhered to a region of the recording medium by the main scanning, the recording medium is then slightly transferred, for example, by the sub scanning, and the following main scanning is further performed, an operation in which the ink composition is adhered adjacent to the ink composition adhered beforehand or is partially laminated and adhered thereto is repeatedly performed, and as a result, the recording can be performed. In addition, the “sub scanning” is also the transfer of the relative position of the ink jet head with respect to the recording medium, and the ink jet head may be transferred with respect to the recording medium, or the recording medium may be transferred with respect to the ink jet head. The direction of the relative transfer as described above is the sub scanning direction.

The recording is preferably performed by performing the main scanning a plurality of times and the sub scanning a plurality of times. For example, the main scanning and the sub scanning may be alternately and repeatedly performed.

### 2.1. First Adhesion Mode

The first adhesion mode is a mode in which the color ink composition and the clear ink composition are sequentially adhered to the recording medium so that the color ink composition and the clear ink composition are laminated to each other. The first adhesion mode is also called lamination printing or lamination ejection. In this mode, in a color ink adhesion step and a clear ink adhesion step which will be described later, a color ink image formed by the color ink composition and a clear ink image formed by the clear ink composition are laminated and formed on the recording medium.

When the first adhesion mode is performed, for example, since the color ink composition and the clear ink composition are adhered to the same scanning region of the recording medium by different main scannings, a layer containing the color ink composition and a layer containing the clear ink composition are laminated and formed on the recording medium.

In addition, the order of adhesion in the first adhesion mode is preferably determined such that after the color ink composition is adhered to the recording medium, the clear ink composition is adhered onto the layer of the color ink composition.

In the first adhesion mode, the different main scannings to adhere the color ink composition and the clear ink composition to scanning regions each may be performed a plurality of times on the same scanning region. For example, the case in which the color ink composition is recorded by 4 passes, and subsequently, the clear ink composition is recorded by 4 passes may be considered.

### 2.2. Second Adhesion Mode

The second adhesion mode is a mode in which the color ink composition and the clear ink composition are simultaneously adhered to the recording medium. The second adhesion mode is also called simultaneous printing or simultaneous ejection. In this mode, the color ink adhesion step and the clear ink adhesion step which will be described later perform the main scanning in a manner such that while the relative position of the ink jet head with respect to the recording medium is transferred, the ink compositions are ejected and adhered to the recording medium, and by the main scanning, the color ink composition and the clear ink composition are adhered to the same scanning region of the recording medium by the same main scanning.

In the second adhesion mode, since the layer of the color ink composition and the layer of the clear ink composition are not required to be laminated to each other, the recording speed can be improved.

When the second adhesion mode is performed, for example, since the color ink composition and the clear ink composition are adhered to the same scanning region of the recording medium by the same main scanning, a layer containing the color ink composition and the clear ink composition is formed. That is, the color ink adhesion step and the clear ink adhesion step are performed by the same main scanning.

In the second adhesion mode, the main scanning to adhere the color ink composition and the clear ink composition to a scanning region may be performed a plurality of times on the same scanning region. That is, after a layer containing the color ink composition and the clear ink composition is adhered to a certain region on the recording medium by one main scanning, furthermore, onto the region described above, a layer containing the color ink composition and the clear ink composition is preferably laminated and adhered by another main scanning. In the case described above, the main scanning to adhere the color ink composition and the clear ink composition is performed over the same region a plurality of times. As the number of scannings is increased, the ink can be adhered to a desired region a plurality of times (a plurality of passes), and hence, the image quality of a recorded matter to be obtained tends to be improved.

In addition, when recording is performed on an arbitrary region, the number of times the ink jet head passes over the above region is called “pass number”. For example, when the main scanning to adhere the color ink composition and the clear ink composition to the same region is performed 4 times, for example, the number of passes is called 4 passes. For example, when the length of one sub scanning in the sub scanning direction is one fourth the length of each of the nozzle lines in the sub scanning direction, the nozzle lines being disposed in the main scanning direction of the ink jet head, with respect to a rectangular scanning region extending in the main scanning direction with a width of one sub scanning length in the sub scanning direction, four main scannings are performed on the same portion (same scanning region). Based on the operation performed as described above, the number of scannings is called the scanning number or the pass number in some cases. The number of scannings is 1 or more, preferably 2 or more, more preferably 3 or more, even more preferably 4 or more, and further preferably 8 or more. Since the image quality is made excellent, the range described above or more is preferable. Although being not particularly limited, an upper limit of the scanning number is preferably 24 or less, more preferably 12 or less, even more preferably 8 or less, and further preferably 4 or less. Since the recording speed is high, the range described above or less is preferable. In addition, the number of scannings described above is to be set for each of respective types of inks.

### 2.3. Color Ink Adhesion Step

The recording method according to this embodiment includes a step (color ink adhesion step) of adhering the color ink composition to the recording medium by an ink jet method.

An adhesion amount of the color ink composition per unit area of the region of the recording medium to which the color ink composition is adhered (hereinafter, referred to as “adhesion region of the color ink composition” in some cases) is preferably 2.0 to 20 mg/inch², more preferably 3.0 to 10 mg/inch², and further preferably 6.0 to 8.0 mg/inch². In addition, among the adhesion amounts of the color ink composition, the maximum adhesion amount may be preferably set in the range described above.

The maximum weight range per one liquid droplet of the color ink composition is preferably 0.5 to 20 ng, more preferably 0.5 to 15 ng, even more preferably 1 to 10 ng, further preferably 3 to 9 ng, and particularly preferably 5 to 8 ng.

### 2.4. Clear Ink Adhesion Step

The recording method according to this embodiment includes a step (clear ink adhesion step) of adhering the clear ink composition to the recording medium by an ink jet method.

An adhesion amount of the clear ink composition per unit area of the region of the recording medium to which the color ink composition and the clear ink composition are laminated and adhered (hereinafter, referred to as “image adhesion region of the clear ink composition” in some cases) is preferably 2.0 to 20 mg/inch², more preferably 3.0 to 10 mg/inch², further preferably 6.0 to 8.0 mg/inch². In addition, among the adhesion amounts of the clear ink composition, the maximum adhesion amount may be preferably set in the range described above.

In the image adhesion region of the clear ink composition, a ratio of the adhesion amount of the clear ink compositions to the adhesion amount of the color ink composition (adhesion amount of the clear ink composition/adhesion amount of the color ink composition) is preferably 0.1 to 2, more preferably 0.5 to 1.8, even more preferably 0.7 to 1.6, further preferably 1.0 to 1.4, and particularly preferably 1.1 to 1.2. When the ratio described above is in the range described above, the dry abrasion resistance and the wet abrasion resistance tend to be made excellent with a good balance.

The maximum weight range per one liquid droplet of the clear ink composition is preferably 0.5 to 20 ng, more preferably 0.5 to 15 ng, even more preferably 1 to 10 ng, further preferably 3 to 9 ng, and particularly preferably 5 to 8 ng.

The recording method according to this embodiment may include a step of adhering the clear ink compositions to a region (non-image portion) of the recording medium to which the color ink composition is not adhered.

In particular, when the recording medium is a polyolefin-based film substrate having a surface with a surface roughness Sa of 0.3 μm or more to which the ink is adhered, since the surface of the non-image portion is rubbed, a fine powder is liable to be generated. Since the fine powder described above abrades an ink coating film in the image portion, the dry abrasion resistance is liable to be degraded. Hence, when the clear ink composition is applied to the non-image portion, the fine powder generated from the surface of the non-image portion is reduced, and as a result, the dry abrasion resistance can be improved.

On the other hand, when the clear ink composition is applied to the non-image portion, since peeling may occur due to a water component, such as moisture, and redispersion of the ink coating film in the image portion may be promoted, the wet abrasion resistance tends to be degraded.

In contrast, by the recording method according to this embodiment, since the clear ink composition is applied to the non-image portion, while the effect to improve the dry abrasion resistance is obtained, a preferable wet abrasion resistance tends to be maintained.

An adhesion amount of the clear ink composition per unit area in the region of the recording medium to which the color ink composition is not adhered is preferably 2.0 to 20 mg/inch², more preferably 4.0 to 12 mg/inch², and further preferably 7.0 to 9.0 mg/inch².

The adhesion amount of the clear ink composition in the region (non-image portion) of the recording medium to which the color ink composition is not adhered and the clear ink composition is adhered is preferably equal to or lower than the adhesion amount of the clear ink composition in the region (image portion) of the recording medium to which the color ink composition and the clear ink composition are laminated and adhered.

In particular, a ratio (adhesion amount of the clear ink composition in the non-image portion/adhesion amount of the clear ink composition in the image portion) of the adhesion amount of the clear ink composition in the region of the recording medium to which the color ink composition is not adhered and the clear ink composition is adhered (adhesion amount of the clear ink composition in the non-image portion) to the adhesion amount of the clear ink composition in the region of the recording medium to which the color ink composition and the clear ink composition are laminated and adhered (adhesion amount of the clear ink composition in the image portion) is preferably 0.1 to 1.0, more preferably 0.3 to 1.0, even more preferably 0.5 to 1.0, further preferably 0.7 to 1.0, and particularly preferably 0.9 to 1.0.

When the adhesion amount relationship is as described above, the wet abrasion resistance is suppressed from being decreased, and the wet abrasion resistance and the dry abrasion resistance tend to be made preferable with a good balance.

### 2.5. Primary Drying Step

The recording method according to this embodiment may also include a primary drying step of drying the ink composition adhered to the recording medium by a drying mechanism. The primary drying step is a step of rapidly drying the ink, for example, by heating the recording medium before the ink adhesion step or by heating the recording medium and/or blowing air thereto in the ink adhesion step or at an early stage after the ink is adhered to the recording medium.

The primary drying step is a step of drying at least a part of the solvent component of the ink so as to at least reduce the fluidity of the ink adhered to the recording medium. The primary drying step may be performed in a manner such that the ink is adhered to a heated recording medium or such that the drying is promoted at an early stage after the ink adhesion.

In the primary drying step, the drying of an ink droplet landed on the recording medium is preferably started within 0.5 seconds at the latest from the landing of the ink droplet. A drying unit (drying mechanism) to dry the ink on the recording medium is not particularly limited, and for example, a platen heater, a hot wind heater, or an IR heater each having a heating function or an air blowing device having no heating function may be mentioned.

As the type of drying mechanism, for example, there may be mentioned a conduction type to heat the recording medium by conducting heat thereto from a member in contact with the recording medium, a radiation type to heat the recording medium by radiating radiant rays, such as IR rays, to the recording medium, or a wind blowing type to blow a wind to the recording medium.

As the wind blowing type, for example, a method to heat the recording medium while a hot wind is blown thereto or a method to promote drying of the ink by an ordinary temperature wind without heating may be mentioned. When the heating is not performed, the ejection stability can be preferably suppressed from being degraded due to the drying of the ink in nozzles of an ink jet head. One of the conduction type and the radiation type is also preferably performed with the wind blowing type. When those types are used in combination, the wind blowing type may also be preferably performed without heating.

In the primary drying step, a surface temperature of the recording medium is preferably 60° C. or less, more preferably 55° C. or less, even more preferably 30° C. to 50° C., and further preferably 40° C. to 45° C. On the other hand, the surface temperature described above is more preferably 40° C. or less, even more preferably 35° C. or less, further preferably 30° C. or less, and particularly preferably 25° C. to 28° C.

When the surface temperature of the recording medium is in the range described above, the drying property is further improved, and the abrasion resistance of a recorded matter to be obtained tends to be further improved. In addition, the clogging recovery property, the ejection stability, and the color development property are preferably made more excellent.

In addition, the primary drying step may be not performed, or a step including heating may be also not performed as the primary drying step, and in the case described above, the surface temperature of the recording medium over the platen may be set in the range described above or less.

When the wind blowing type is used, a wind velocity in the vicinity of the recording medium is preferably 0.5 to 10 m/s, more preferably 1 to 5 m/s, and further preferably 2 to 3 m/s. A wind temperature is preferably 45° C. or less, more preferably 40° C. or less, further preferably 32° C. or less, and particularly preferably 20° C. to 27° C.

### 2.6. Secondary Heating Step

The recording method according to this embodiment may also include a heating step (secondary heating step) of heating the recording medium to which the color ink composition and the clear ink composition are adhered. The secondary heating step is a step of performing a sufficient heating to complete the recording so that the recorded matter is ready to be used. In addition, the secondary heating step is a step of sufficiently drying the solvent component of the ink and heating the resin and the like contained in the ink to form a coating film thereof.

The secondary heating step is preferably started more than 0.5 seconds after the adhesion of the ink to the recording medium. For example, after the adhesion of the ink to the recording region of the recording medium is thoroughly completed, the heating is preferably started more than 0.5 seconds on the recording region described above.

A surface temperature of the recording medium in the secondary heating step is preferably 50° C. or more, more preferably 60° C. or more, and further preferably 70° C. or more. In the secondary heating step, when the surface temperature of the recording medium is increased to 60° C. or more, the drying property is made excellent, and the wet abrasion resistance tends to be made more preferable.

In addition, as a secondary heating mechanism, for example, a conduction type, a radiation type, or a wind blowing type may be used.

### 2.7 Recording Apparatus

One example of a recording apparatus suitably used for the recording method according to this embodiment will be described with reference to the drawings.

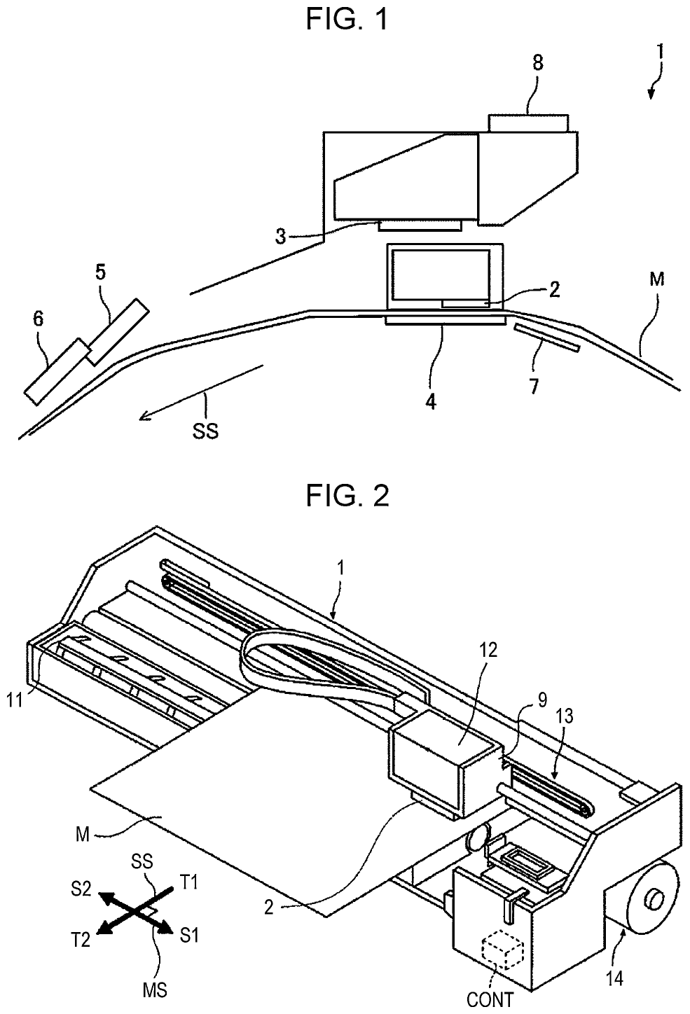

FIG. 1 is a schematic cross-sectional view showing an ink jet recording apparatus 1. FIG. 2 is a perspective view showing one example of the structure in the vicinity of a carriage of the ink jet recording apparatus 1 in FIG. 1. As shown in FIGS. 1 and 2, the ink jet recording apparatus 1 includes an ink jet head 2, an IR heater 3, a platen heater 4, a heating heater 5, a cooling fan 6, a pre-heater 7, a ventilation fan 8, a carriage 9, a platen 11, a carriage transfer mechanism 13, and a transport device 14, and a control portion CONT. All operation of the ink jet recording apparatus 1 is controlled by the control portion CONT shown in FIG. 2.

The ink jet head 2 includes an ink jet head 2a to eject the color ink composition and an ink jet head 2b to eject the clear ink composition, and since the color ink composition and the clear ink composition are ejected from nozzles of the respective ink jet heads and are adhered to a recording medium M, the recording can be performed thereon.

In this embodiment, the ink jet head 2 is a serial type ink jet head and is scanned a plurality of times in the main scanning direction relatively to the recording medium M so that the color ink composition and the clear ink composition are adhered to the recording medium M. The ink jet head 2 is mounted in the carriage 9 shown in FIG. 2. The ink jet head 2 is scanned a plurality of times in the main scanning direction relatively to the recording medium M by the operation of the carriage transfer mechanism 13 to transfer the carriage 9 in a medium width direction of the recording medium M. The medium width direction is the main scanning direction of the ink jet head 2. The scanning in the main scanning direction is also called the main scanning.

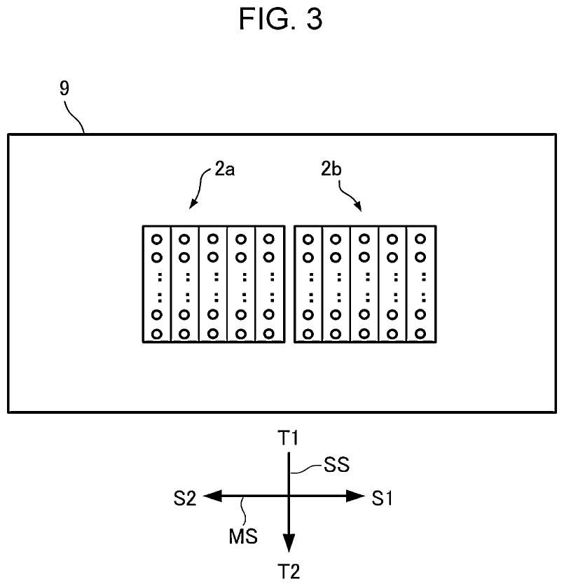

FIG. 3 shows the arrangement in which the ink jet head 2a to eject the color ink composition and the ink jet head 2b to eject the clear ink composition are disposed adjacent to each other at the same position with respect to the transport direction (T2 direction) of the recording medium M. For example, according to the arrangement as described above, by the mode (the second adhesion mode) in which the color ink composition and the clear ink composition are simultaneously adhered to the recording medium, the color ink composition and the clear ink composition can be laminated and adhered. In addition, the nozzle lines shown in FIG. 3 are nozzle lines of the respective ink jet heads to eject the inks.

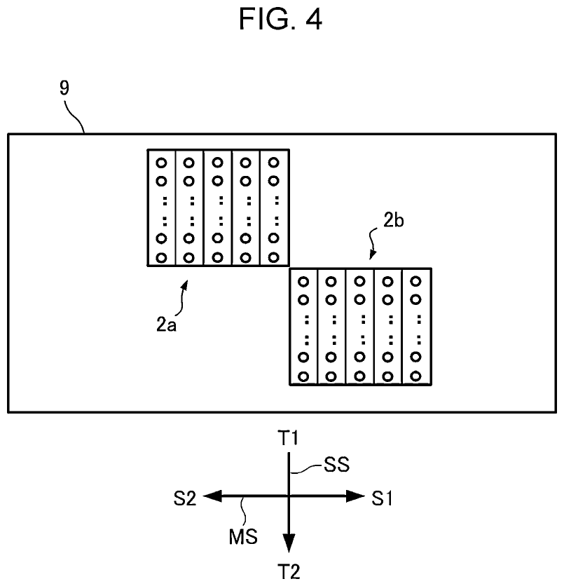

FIG. 4 shows the arrangement in which the ink jet head 2b to eject the clear ink composition is disposed downstream of the ink jet head 2a to eject the color ink composition with respect to the transport direction (T2 direction) of the recording medium M. For example, according to the arrangement as described above, by the mode (the first adhesion mode) in which the color ink composition and the clear ink composition are sequentially adhered to the recording medium and are laminated to each other, the color ink composition and the clear ink composition can be laminated and adhered. In addition, the nozzle lines shown in FIG. 4 are nozzle lines of the respective ink jet heads to eject the inks.

In addition, the main scanning direction is a direction in which the carriage 9 mounting the ink jet head 2 is transferred. In FIG. 1, the main scanning direction is a direction intersecting the sub scanning direction which is the transport direction of the recording medium M shown by an arrow SS. In FIG. 2, the width direction of the recording medium M, that is, the direction represented by S1-S2, is a main scanning direction MS, and a direction represented by T1→T2 is a sub scanning direction SS. In addition, by one scanning in the main scanning direction, the scanning is performed in one of the directions represented by an arrow Si and an arrow S2. In addition, since the main scanning of the ink jet head 2 and the sub scanning to transport the recording medium M are repeatedly performed a plurality of times, the recording can be performed on the recording medium M. That is, the color ink adhesion step and the clear ink adhesion step are carried out by performing the main scanning to transfer the ink jet head 2 in the main scanning direction a plurality of times and the sub scanning to transport the recording medium M in the sub scanning direction intersecting the main scanning direction a plurality of times.

A cartridge 12 to supply the inks to the ink jet head 2 includes a plurality of independent cartridges. The cartridge 12 is detachably fitted to the carriage 9 mounting the ink jet head 2. In the independent cartridges, different types of inks can be filled, and the inks are supplied to respective nozzles from the cartridge 12. In addition, in this embodiment, although the case in which the cartridge 12 is mounted in the carriage 9 is shown by way of example, the structure is not limited thereto, and the case in which the cartridge 12 is provided at a position other than that of the carriage 9, and the inks are supplied to the respective nozzles using supply tubes (not shown) may also be mentioned.

For the ejection from the ink jet head 2, a known method may be used. In this embodiment, a method to eject liquid droplets using vibration of a piezoelectric element, that is, an ejection method to form ink droplets by mechanical deformation of an electrostrictive element, is used.

The ink jet recording apparatus 1 includes, in order to dry the ink ejected from the ink jet head 2 and adhered to the recording medium M, the ventilation fan 8, the IR heater 3, and the platen heater 4. When those heaters described above, that is, the ventilation fan 8, the IR heater 3, and the platen heater 4, are appropriately used in combination, the primary drying step can be performed. In the primary drying step, the recording medium M is not always required to be heated, and the ventilation fan 8 may only be used to blow a wind at an ordinary temperature.

In addition, when the IR heater 3 is used, by radiation of infrared rays from the ink jet head 2 side, the recording medium M can be heated by a radiation type. Accordingly, although the ink jet head 2 is also liable to be heated at the same time, compared to the case in which the recording medium M is heated from a rear side thereof by the platen heater 4 or the like, the temperature can be increased without receiving the influence of the thickness of the recording medium M. In addition, various types of fans (such as the ventilation fan 8) may also be provided to dry the ink on the recording medium M by blowing a hot wind or a wind having the same temperature as that of the atmosphere to the recording medium M.

In order to rapidly dry the ink ejected from the ink jet head 2 and adhered to the recording medium M, the platen heater 4 can heat the recording medium M at a position facing the ink jet head 2 with the platen 11 interposed therebetween. The platen heater 4 is a heater capable of heating the recording medium M by a conduction type, and accordingly, the ink can be adhered to a heated recording medium M.

In addition, the surface temperature of the recording medium M by heating using the IR heater 3 and the platen heater 4 is preferably set in the range described in the above primary drying step.

The heating heater 5 is a heater to dry and fix the ink adhered to the recording medium M, that is, is a heater for secondary heating. The heating heater 5 can be used in the secondary heating step. Since the heating heater 5 heats the recording medium M on which an image is recorded, moisture or the like contained in the ink can be rapidly evaporated and scattered, and by the resin contained in the clear ink composition, an ink film is formed. As described above, since the ink film is tightly fixed or adhered onto the recording medium M, the film forming property is made excellent, and hence, an excellent high quality image can be obtained in a short time.

The surface temperature of the recording medium M by heating using the heating heater 5 is preferably in the range described in the above secondary heating step. Since the temperature is in the range described above, a high quality image tends to be obtained in a short time.

The ink jet recording apparatus 1 may also include the cooling fan 6. After the ink recorded on the recording medium M is dried, since the ink on the recording medium M is cooled by the cooling fan 6, the ink coating film can be formed on the recording medium M with a good adhesion.

In addition, the ink jet recording apparatus 1 may also include the pre-heater 7 to heat the recording medium M in advance before the ink is adhered to the recording medium M. Furthermore, the ink jet recording apparatus 1 may also include the ventilation fan 8 to more efficiently dry the ink adhered to the recording medium M.

Under the carriage 9, the platen 11 to support the recording medium M, the carriage transfer mechanism 13 to transfer the carriage 9 relatively to the recording medium M, and the transport device 14 which is a roller to transport the recording medium M in the sub scanning direction are provided. The operation of the carriage transfer mechanism 13 and that of the transport device 14 are controlled by the control portion CONT.

In an embodiment other than that described above, the ink jet recording apparatus may be a line type ink jet recording apparatus in which the ink jet head 2 is a line head. For example, in FIG. 1, the ink jet head 2 is a line head having a length equal to or longer than a recording width of the recording medium in the width direction, and the position of the line head 2 is fixed. With respect to the recording medium M which is transported, the ink is ejected from the ink jet head 2 and is adhered to the recording medium. In the case described above, the recording is performed by one main scanning. When the ink jet head 2 is the line head, the structure other than that described above may be configured in a manner similar to that of the serial type described above.

### 3. Examples

Hereinafter, although the present disclosure will be described in more detail with reference to Examples, the present disclosure is not at all limited to the following Examples. Hereinafter, unless otherwise particularly noted, “%” is represented on a mass basis.

### 3.1. Preparation of Color Ink Composition and Clear Ink Composition

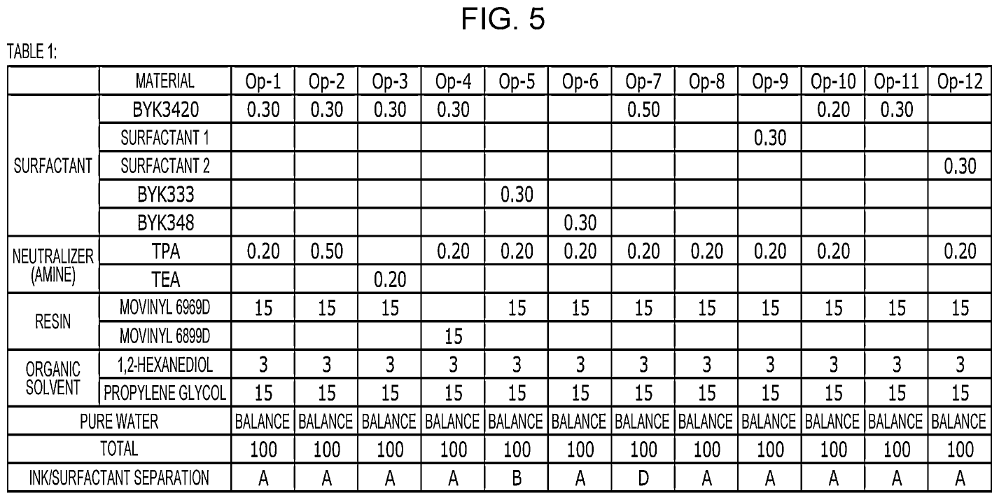

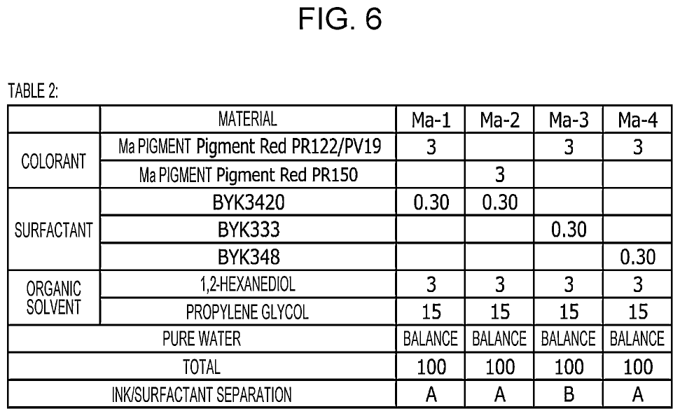

The color ink composition and the clear ink composition used in each Example and each Comparative Example were obtained as described below. That is, in order to obtain the composition shown in TABLE 1 (FIG. 5) as the clear ink composition and the composition shown in TABLE 2 (FIG. 6) as the color ink composition, after components were charged in a container, and pure water was then added therein so that the total mass was 100 percent by mass, the mixture thus obtained was mixed and stirred for 2 hours using a magnetic stirrer and was further sufficiently mixed and stirred for 1 hour by a dispersion treatment using a bead mill filled with zirconia beads having a diameter of 0.3 mm, and filtration was finally performed using a PTFE-made membrane filter having a pore size of 5 μm. The units of the numerical values shown in TABLEs 1 and 2 are each represented by percent by mass.

In addition, a colorant (pigment) used for the preparation of the color ink composition and a pigment dispersant (not shown in the table) which was a water-soluble styrene-acrylic-based resin were mixed together with water in advance at a mass ratio of 2:1 (pigment: pigment dispersant) and were then sufficiently stirred to prepare a pigment dispersion liquid, and the pigment dispersion liquid thus obtained was used for the preparation of the ink. In addition, in the column of the colorant, the content of the pigment obtained by conversion from the solid content concentration of the pigment dispersion liquid is represented by “percent by mass”. In addition, in TABLE 1, the net addition amount of the resin obtained from the solid content of the emulsion is shown.

“Surfactant 1” of the surfactant shown in TABLE 1 was obtained by the following synthesis.

The surfactant represented by the formula (1) was synthesized using the compound represented by the formula (A) and the compound represented by the formula (B).

In 20 mL of a tetrahydrofuran solution containing 7.0 g of hexamethylene glycol monoallyl ether (compound represented by the formula (B) in which c was 6, R⁶ was an ethylene group, and R⁷ was a hydroxy group), 5.8 g of the compound represented by the formula (A) in which b was 7 and 0.1 mL of chloroplatinic acid were added and then held at 65° C. for 24 hours with stirring, so that the reaction was performed. After the reaction was completed, the solvent was distilled off using a rotary evaporation, so that a silicone-based surfactant (surfactant 1) was obtained. In a manner similar to that described above, except for that b of the formula (A) was changed, a silicone-based surfactant (surfactant 2) was obtained.

The structure of the silicone-based surfactant (surfactant 1) was, in the formula (1), such that a=7, x, y=3, n, m=7, o, p=0, and R1, R2=hydroxy group hold.

The structure of the silicone-based surfactant (surfactant 2) was, in the formula (1), such that a=17, x, y=3, n, m=7, o, p=0, and R1, R2=hydroxy group hold.

The items mentioned in TABLEs 1 and 2 are additionally described as follows.

### Surfactant

BYK-3420 (silicone-based surfactant having a dissolution amount of 2.5 parts by mass with respect to 100 parts by mass of a 1,2-hexanediol aqueous solution at a concentration of 3 percent by mass; in a molecular weight distribution by GPC, the maximum peak in a molecular weight range of 300 or more is located at a molecular weight of 1,610; trade name, manufactured by BYK Japan KK)
Silicone-based surfactant (surfactant 1) (silicone-based surfactant having a dissolution amount of 2.9 parts by mass with respect to 100 parts by mass of a 1,2-hexanediol aqueous solution at a concentration of 3 percent by mass; in a molecular weight distribution by GPC, the maximum peak in a molecular weight range of 300 or more is located at a molecular weight of 1,300.)
Silicone-based surfactant (surfactant 2) (silicone-based surfactant having a dissolution amount of 1.7 parts by mass with respect to 100 parts by mass of a 1,2-hexanediol aqueous solution at a concentration of 3 percent by mass; in a molecular weight distribution by GPC, the maximum peak in a molecular weight range of 300 or more is located at a molecular weight of 2,000.)
BYK-333 (silicone-based surfactant having a dissolution amount of 0.7 parts by mass with respect to 100 parts by mass of a 1,2-hexanediol aqueous solution at a concentration of 3 percent by mass; in a molecular weight distribution by GPC, the maximum peak in a molecular weight range of 300 or more is located in a molecular weight range of 4,000 to 7,000; trade name, manufactured by BYK Japan KK)
BYK-348 (silicone-based surfactant having a dissolution amount of 5 parts by mass with respect to 100 parts by mass of a 1,2-hexanediol aqueous solution at a concentration of 3 percent by mass; in a molecular weight distribution by GPC, the maximum peak in a molecular weight range of 300 or more is located at a molecular weight of 1,540; trade name, manufactured by BYK Japan KK)

In addition, the measurement conditions of the GPC measurement for the surfactant were as shown below.

### Measurement Conditions

Solvent: tetrahydrofuran
Column: TSKgel SuperHZM-N×2+TSKgel guardcolumn Super HZ-L
Column temperature: 40° C.
Charge amount: 25 μL
Detector: differential refractometry (RI)
Flow rate: 0.35 mL/min
Calibration curve: calibration curve prepared using 13 samples of standard polystyrenes STK Standard Polystyrenes (manufactured by Tosoh Corporation) having Mw of 1,000,000 to 500 was used.

### Neutralizer (Amine)

TEA (triethanolamine, standard boiling point: 335° C.)
TPA (triisopropanolamine, standard boiling point: 305° C.)

### Resin

Movinyl 6969D (acrylic-based resin emulsion, glass transition temperature: 71° C., trade name, manufactured by The Nippon Synthetic Chemical Industry Co., Ltd.)
Movinyl 6899D (acrylic-based resin emulsion, glass transition temperature: 49° C., trade name, manufactured by The Nippon Synthetic Chemical Industry Co., Ltd.)

### 3.2. Printing Conditions

The recording in the evaluation test was performed under the following conditions.
Printing machine: Sure Press L-4533AW (modified machine, manufactured by Seiko Epson Corporation, resolution: 1,440×1,440 dpi)
Printing pattern: in the image portion, a solid pattern is formed, and in the non-image portion which is the entire recording region of the recording medium other than the image portion, no color ink composition is adhered.
Color conditions: 7 mg/inch², Iw=6 ng/dot
Clear conditions: adhesion amounts are shown in TABLEs 3 and 4, Iw=6 ng/dot
Number of scannings: shown in TABLEs 3 and 4.
Surface temperature of recording medium at platen (primary drying step): 45° C. as surface temperature of recording medium
Secondary heating temperature (furnace temperature): shown in TABLEs 3 and 4.
Recording medium: shown in TABLEs 3 and 4.

In addition, the “solid pattern” indicates a pattern in which dots are recorded on all the pixels each of which is the minimum recording unit region defined by the recording resolution.

The “secondary heating temperature” is a surface temperature of the recording medium on which the secondary heating step is performed after the recording medium passes over the platen.

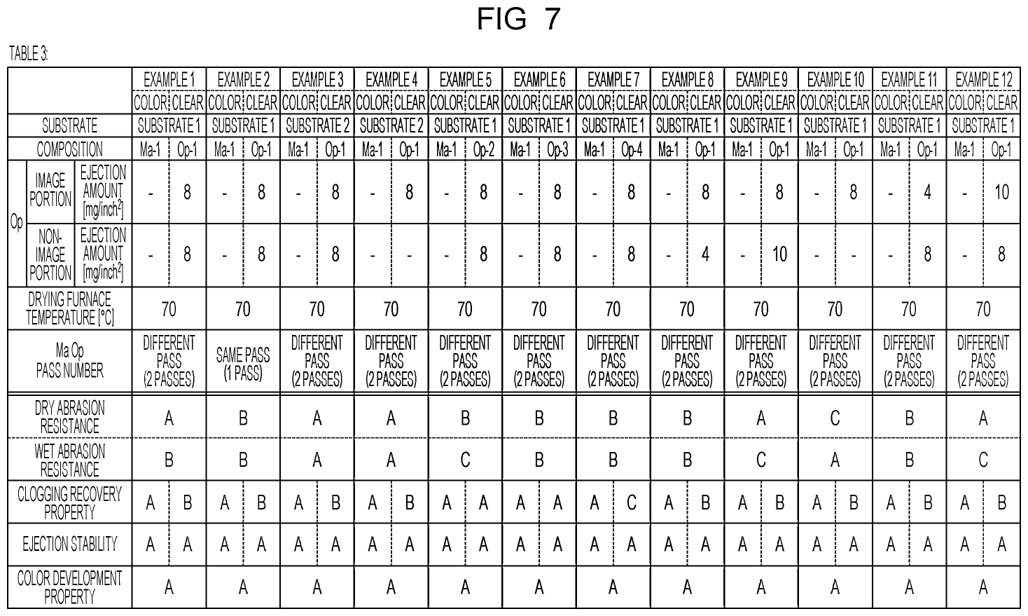

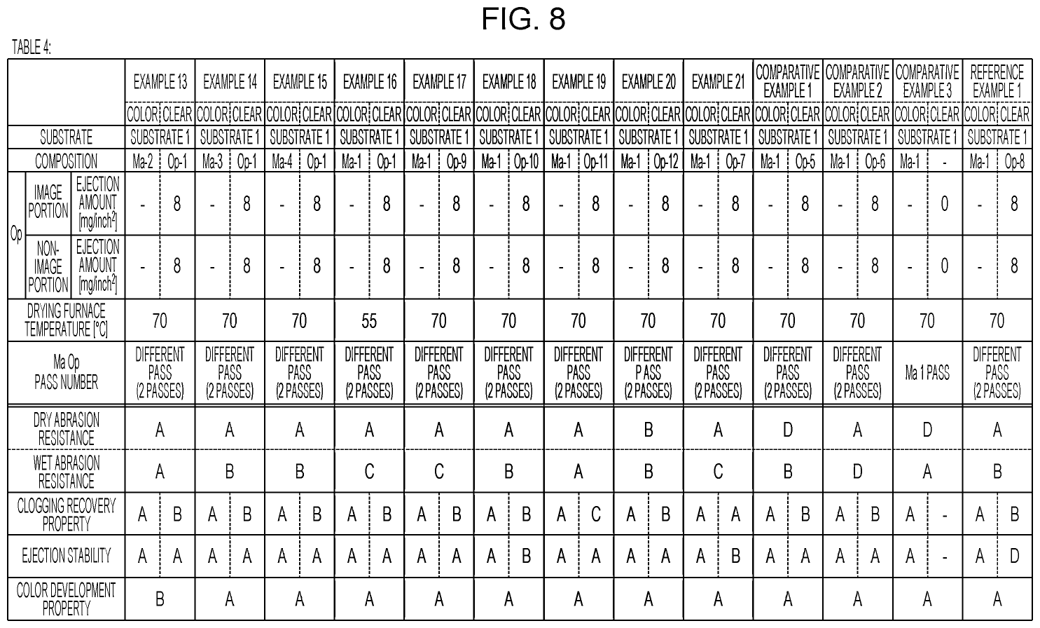

In TABLE 3 (FIG. 7) and TABLE 4 (FIG. 8), the “substrate 1” represents a recording medium which is named “YUPO#80” (trade name, manufactured by UPO Corporation) and which is a polypropylene-based film substrate having a surface with a surface roughness Sa of 0.6 μm to which the ink is to be adhered.

The “substrate 2” represents a recording medium which is named “PET50A” (trade name, manufactured by Lintec Corporation) and which is a PET-based film substrate having a surface with a surface roughness Sa of 0.02 μm to which the ink is to be adhered.

In addition, the surface roughness Sa was measured by a method in accordance with ISO 25178 using a laser microscope (VK-X1000/manufactured by Keyence Corporation). The object lens magnification was set to 20 times, and the average value obtained from the results of measurement which was performed 3 times was used.

“Op” represents the clear ink composition.

“Ma” represents the color ink composition.

The “image portion” indicates a region in which the color ink composition and the clear ink composition are laminated and adhered to the recording medium.

The “non-image portion” indicates a region of the recording medium to which the color ink composition is not adhered, is a portion adjacent to the periphery of the color ink image, and also indicates the entire recording portion of the recording medium other than the image portion.

“Different pass” indicates the mode in which the color ink composition and the clear ink composition are sequentially adhered to the recording medium and are laminated to each other, that is, the color ink composition and the clear ink composition are adhered to the same scanning region of the recording medium by different main scannings.

“Same pass” indicates the mode in which the color ink composition and the clear ink composition are simultaneously adhered to the recording medium, that is, the color ink composition and the clear ink composition are adhered to the same scanning region of the recording medium by the same main scanning.

### 3.3. Evaluation Test

### 3.3.1. Dry Abrasion Resistance

After the color ink composition and the clear ink composition obtained as described above were filled in the printer, the solid pattern was printed on the recording medium under the printing conditions described above and was then left over one night at a room temperature.

Subsequently, after a solid pattern printing portion was cut into a rectangular shape having a size of 30×200 mm, the sample thus obtained was rubbed 50 times using a Gakushin-type rubbing tester (load: 500 g) with a plain-woven cloth, and the degree of ink peeling was evaluated by visual inspection.

### (Evaluation Criteria)

A: no peeling occurs.
B: less than 10% of evaluation area is peeled off.
C: 10% to less than 50% of evaluation area is peeled off.
D: 50% or more of evaluation area is peeled off (NG).

### 3.3.2. Wet Abrasion Resistance

After the color ink composition and the clear ink composition obtained as described above were filled in the printer, the solid pattern was printed on the recording medium under the printing conditions described above and was then left over one night at a room temperature.

Subsequently, after a solid pattern printing portion was cut into a rectangular shape having a size of 30×200 mm, the sample thus obtained was rubbed 50 times using a Gakushin-type rubbing tester (load: 500 g) with a plain-woven cloth to which 5 droplets of water were dripped in advance, and the degree of ink peeling was evaluated by visual inspection.
A: no peeling occurs.
B: less than 10% of evaluation area is peeled off.
C: 10% to less than 50% of evaluation area is peeled off.
D: 50% or more of evaluation area is peeled off (NG).

### 3.3.3. Clogging Recovery Property

After the color ink composition and the clear ink composition obtained as described above were filled in the printer, non-ejection nozzles were intentionally generated. In the state as described above, an idle printing was performed under the printing conditions described above for 90 minutes. After the idle printing described above was performed, cleaning was performed 3 times, and the degree of generation of non-ejection nozzles was finally evaluated in accordance with the following criteria. By one cleaning, 1 g of the ink was discharged from the nozzle line. In addition, the non-ejection nozzles were generated by patting the nozzle surfaces by BEMCOT wetted with water.

### Evaluation Criteria

A: No non-ejection nozzles are observed.
B: Non-ejection nozzles are less than 3% of all nozzles.
C: Non-ejection nozzles are 3% to less than 5% of all nozzles.
D: Non-ejection nozzles are 5% or more of all nozzles.

### 3.3.4. Ejection Stability

After the color ink composition and the clear ink composition obtained as described above were filled in the printer, an image recording was performed continuously for 1 hour under the printing conditions described above, and after the recording, nozzles of an ejection nozzle group were inspected. The number of total non-ejection nozzles was divided by the number of total nozzles (hereinafter, referred to as “non-ejection nozzle rate” in some cases) and was then evaluated in accordance with the following criteria.

### Evaluation Criteria

A: Non-ejection nozzle rate is 1% or less.
B: Non-ejection nozzle rate is more than 1% to 2%.
C: Non-ejection nozzle rate is more than 2% to less than 5%.
D: Non-ejection nozzle rate is 5% or more.

### 3.3.5. Ink/Surfactant Separation

After 30 g of each of the ink compositions obtained as described above was sealed in a sample tube, the ink composition thus sealed was left at 70° C. in a temperature-constant bath for 6 days. Immediately after the ink composition was recovered and after the ink composition was spontaneously cooled, whether or not the surfactant was separated from the ink to form two layers was observed, and the evaluation was performed in accordance with the following criteria.

### Evaluation Criteria

A: Even immediately after recovery, no separation occurs.
B: Although separation occurs immediately after recovery, when the ink composition is cooled for several minutes, the surfactant is again dissolved.
C: Although separation occurs immediately after recovery, when the ink composition is cooled for several tens of minutes, the surfactant is again dissolved.
D: Immediately after recovery, separation occurs, and even when the ink composition is left for hours, the surfactant is not again dissolved.

### 3.3.6. Color Development Property

After the color ink composition and the clear ink composition obtained as described above were filled in the printer, and the solid pattern was printed under the printing conditions described above, the c* value (c*=(a*²+b*²)^{1/2}) of a printed matter was measured and then evaluated in accordance with the following criteria. In addition, as a measurement device, “ilPro2” (manufactured by X-Rite) was used, and as the measurement conditions, a D50 light source, Status T, and a 2° standard observer were employed.

### Evaluation Criteria

A: c* value is high. Pattern of Example 1 is regarded as 100%.
B: c* value is 90% to less than 100% of c* of rank A.
C: c* value is 80% to less than 90% of c* of rank A.
D: c* value is less than 80% of c* of rank A.

### 3.4. Evaluation Results

The evaluation results are shown in TABLEs 3 and 4.

From the results shown in TABLEs 3 and 4, it was found that when an ink set comprising a color ink composition and a clear ink composition is used, the ink set being used for a recording method in which the color ink composition and the clear ink composition are laminated and adhered to a recording medium by an ink jet method, the color ink composition being an aqueous composition which contains a colorant, and the clear ink composition being an aqueous composition which contains a resin and a silicone-based surfactant having a dissolution amount of 1.0 to 3.0 parts by mass with respect to 100 parts by mass of a 1,2-hexanediol aqueous solution at a concentration of 3 percent by mass, the dry abrasion resistance and the wet abrasion resistance are both excellent.

On the other hand, it was found that in Comparative Examples in which the structures described above are not satisfied, at least one of the dry abrasion resistance and the wet abrasion resistance is inferior.

The evaluation results will be additionally explained as described below.

In Example 4, although the clear ink composition was not adhered to the non-image portion, since the substrate 2 was used, a fine powder was not generated at the non-image portion of the recording medium, and the dry abrasion resistance was not adversely influenced. On the other hand, in Example 10, since the substrate 1 was used, when the clear ink composition was not adhered to the non-image portion, a fine powder was generated at the non-image portion of the recording medium, and as a result, the dry abrasion resistance was degraded.

In Reference Example 1, since no surfactant was contained in the clear ink composition, although the ejection stability was inferior, and the ink jet method was difficult to perform, problems on the dry abrasion resistance and the wet abrasion resistance were not generated.

In addition, although being not shown in the table, in each Example, except for that the surface temperature of the recording medium in the primary drying step was set to 30° C., when the evaluation was performed in a manner similar to that shown in the table, the result of the abrasion resistance of each Example was not changed from that shown in the table, and the clogging recovery property and the ejection stability were improved. Even when the surface temperature of the recording medium in the primary drying step was further decreased, an excellent abrasion resistance was obtained.

From the embodiments described above, the following conclusions can be obtained.

An ink set according to an aspect of the present disclosure, includes a color ink composition and a clear ink composition, the ink set being used for a recording method in which the color ink composition and the clear ink composition are laminated and adhered to a recording medium by an ink jet method, the color ink composition is an aqueous composition containing a colorant, and the clear ink composition is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

In the ink set according to the aspect of the present disclosure, a content of the silicone-based surfactant with respect to a total mass of the clear ink composition may be 0.3 percent by mass or less.

In the ink set according to the aspect of the present disclosure, the recording medium may be a polyolefin-based film substrate having a surface with a surface roughness Sa of 0.3 μm or more to which the ink is to be adhered.

In the ink set according the aspect of the present disclosure, the clear ink composition may further contain an amine having a standard boiling point of 250° C. or more.

In the ink set described above, a content of the amine with respect to a total mass of the clear ink composition may be 0.4 percent by mass or less.

In the ink set according to the aspect of the present disclosure, the resin contained in the clear ink composition may have a glass transition temperature Tg of 60° C. or more.

In the ink set according to the aspect of the present disclosure, the colorant contained in the color ink composition may be a quinacridone-based pigment.

In the ink set according to the aspect of the present disclosure, the silicone-based surfactant may be a silicone-based surfactant in which in a molecular weight distribution by a gel permeation chromatography, the maximum peak in a molecular weight range of 300 or more is located in a molecular weight range of 1,000 to 3,000.

A recording method according to another aspect of the present disclosure uses the ink set according to the aspect described above and includes a step of adhering the color ink composition to a recording medium by an ink jet method and a step of adhering the clear ink composition to the recording medium by an ink jet method, and the color ink composition and the clear ink composition are laminated and adhered to the recording medium.

The recording method according to the another aspect of the present disclosure, may further include a step of adhering the clear ink composition to a region of the recording medium to which the color ink composition is not adhered.

In the recording method described above, an adhesion amount of the clear ink composition in the region of the recording medium to which the color ink composition is not adhered and the clear ink composition is adhered may be equal to or less than an adhesion amount of the clear ink composition in a region of the recording medium to which the color ink composition and the clear ink composition are laminated and adhered.

The recording method according to the another aspect of the present disclosure, may further include a heating step of heating the recording medium to which the color ink composition and the clear ink composition are adhered so that the recording medium has a surface temperature of 60° C. or more.

The present disclosure is not limited to the embodiments described above and may be variously changed and modified. For example, the present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

What is claimed is:

1. An ink set comprising:
a color ink composition; and
a clear ink composition, the ink set being used for a recording method in which the color ink composition and the clear ink composition are laminated and adhered to a recording medium by an ink jet method,
wherein the color ink composition is an aqueous composition containing a colorant, and
the clear ink composition is an aqueous composition containing a resin and a silicone-based surfactant which has a dissolution amount of 1.0 to 3.0 parts by mass with respect to 100 parts by mass of a 1,2-hexanediol aqueous solution at a concentration of 3 percent by mass.

2. The ink set according to claim 1,
wherein a content of the silicone-based surfactant with respect to a total mass of the clear ink composition is 0.3 percent by mass or less.

3. The ink set according to claim 1,
wherein the recording medium is a polyolefin-based film substrate having a surface with a surface roughness Sa of 0.3 μm or more to which the ink is to be adhered.

4. The ink set according to claim 1,
wherein the clear ink composition further contains an amine having a standard boiling point of 250° C. or more.

5. The ink set according to claim 4,
wherein a content of the amine with respect to a total mass of the clear ink composition is 0.4 percent by mass or less.

6. The ink set according to claim 1,
wherein the resin contained in the clear ink composition has a glass transition temperature Tg of 60° C. or more.

7. The ink set according to claim 1,
wherein the colorant contained in the color ink composition is a quinacridone-based pigment.

8. The ink set according to claim 1,
wherein the silicone-based surfactant is a silicone-based surfactant in which in a molecular weight distribution by a gel permeation chromatography, the maximum peak in a molecular weight range of 300 or more is located in a molecular weight range of 1,000 to 3,000.

9. A recording method using the ink set according to claim 1, comprising:
adhering the color ink composition to a recording medium by an ink jet method; and
adhering the clear ink composition to the recording medium by an ink jet method,
wherein the color ink composition and the clear ink composition are laminated and adhered to the recording medium.

10. The recording method according to claim 9, further comprising:
adhering the clear ink composition to a region of the recording medium to which the color ink composition is not adhered.

11. The recording method according to claim 10,
wherein an adhesion amount of the clear ink composition in the region of the recording medium to which the color ink composition is not adhered and the clear ink composition is adhered is equal to or less than an adhesion amount of the clear ink composition in a region of the recording medium to which the color ink composition and the clear ink composition are laminated and adhered.

12. The recording method according to claim 9, further comprising:
a heating step of heating the recording medium to which the color ink composition and the clear ink composition are adhered so that the recording medium has a surface temperature of 60° C. or more.
